(19) United States
(12) Patent Application Publication
(10) Pub. No.: US 2026/0042920 A1
(43) Pub. Date: Feb. 12, 2026

(54) COATINGS WITH IMPROVED DIRT PICK UP RESISTANCE AND ANTICORROSIVE PROPERTIES

(71) Applicant: W.R. Grace & Co.-CONN., Columbia, MD (US)

(72) Inventors: Demetrius Michos, Columbia, MD (US); Charles Myer, Columbia, MD (US); Feng Gu, Elliott City, MD (US); Manoj Koranne, Columbia, MD (US)

(21) Appl. No.: 19/293,274

(22) Filed: Aug. 7, 2025

Related U.S. Application Data
(60) Provisional application No. 63/680,566, filed on Aug. 7, 2024.

(51) Int. Cl. C09D 7/62; C08K 3/36; C08K 9/06; C09D 5/02; C09D 5/08; C09D 7/80; C09D 133/04

(52) U.S. Cl. CPC C09D 7/62; C08K 3/36; C08K 9/06; C09D 5/028; C09D 7/80; C09D 133/04; C09D 5/084

(57) ABSTRACT

The present disclosure is directed to coating compositions that include about 10 wt. % to about 90 wt. % water, about 5 wt. % to about 80 wt. % of a binder, and about 0.1 wt. % to about 20 wt. % of a colloidal silica functionalized with anionic molecules and/or a colloidal silica functionalized with neutral molecules. The present disclosure also is directed to methods of making coating compositions of the present technology.

### TECHNICAL FIELD

The present technology relates generally to coating compositions including functionalized colloidal silica, as well as methods useful for synthesizing such coating compositions, including coating compositions with excellent dirt pick up resistance (DPUR) and/or anti-corrosive properties.

### SUMMARY

In an aspect, the present disclosure provides a coating composition including about 10 wt. % to about 90 wt. % water, about 5 wt. % to about 80 wt. % of a binder, and about 0.1 wt. % to about 20 wt. % of a colloidal silica functionalized with anionic molecules and/or a colloidal silica functionalized with neutral molecules.

In another aspect, the present technology provides a method of making a coating composition, the method including combining water, a binder, and a colloidal silica functionalized with anionic molecules and/or a colloidal silica functionalized with neutral molecules to generate a first mixture, where the first mixture includes about 1 wt. % to about 50 wt. % water, about 5 wt. % to about 80 wt. % of the binder, and about 0.1 wt. % to about 20 wt. % of the colloidal silica functionalized with anionic molecules and/or the colloidal silica functionalized with neutral molecules.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

### BRIEF DESCRIPTION OF THE DRAWING

FIGS. 1A-1C provide photographs of examples of coatings with different dirt pickup ratings. FIG. 1A is a photograph of a coating with a DPUR rating of 1. FIG. 1B is a photograph of a coating with a DPUR rating of 2. FIG. 1C is a photograph of a coating with a DPUR rating of 3.

FIG. 2 provides photographs of the results of different coatings following accelerated corrosion testing according to ASTM B117 salt spray protocols, according to the working examples, showing the differences between Examples 5A, 5B, and 5C of the present technology alongside Comparative Examples 5a, 50, and 57 not of the present technology.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein and in the appended claims, singular articles such as “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term—for example, “about 10 wt. %” would be understood to mean “9 wt. % to 11 wt. %.” It is to be understood that when “about” precedes a term, the term is to be construed as disclosing “about” the term as well as the term without modification by “about”—for example, “about 10 wt. %” discloses “9 wt. % to 11 wt. %” as well as disclosing “10 wt. %.”

The phrase “and/or” as used in the present disclosure will be understood to mean any one of the recited members individually or a combination of any two or more thereof—for example, “A, B, and/or C” would mean “A or B or C; A and B; A and C; B and C; or the combination of A, B, and C.”

Generally, reference to a certain element such as hydrogen or H is meant to include all isotopes of that element. For example, if an R group is defined to include hydrogen or H, it also includes deuterium and tritium. Compounds comprising radioisotopes such as tritium, C¹⁴, P³² and S³⁵ are thus within the scope of the present technology. Procedures for inserting such labels into the compounds of the present technology will be readily apparent to those skilled in the art based on the disclosure herein.

In general, “substituted” refers to an organic group as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group is substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, aryloxy, aralkyloxy, heterocyclyl, heterocyclylalkyl, heterocyclyloxy, and heterocyclylalkoxy groups; carbonyls (oxo); carboxylates; esters; urethanes; oximes; hydroxylamines; alkoxyamines; aralkoxyamines; thiols; sulfides; sulfoxides; sulfones; sulfonyls; pentafluorosulfanyl (i.e., SF₅), sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; and nitriles (i.e., CN).

Substituted ring groups such as substituted cycloalkyl, aryl, heterocyclyl and heteroaryl groups also include rings and ring systems in which a bond to a hydrogen atom is replaced with a bond to a carbon atom. Therefore, substituted cycloalkyl, aryl, heterocyclyl and heteroaryl groups may also be substituted with substituted or unsubstituted alkyl, alkenyl, and alkynyl groups as defined below.

Alkyl groups include straight chain and branched chain alkyl groups having from 1 to 12 carbon atoms, and typically from 1 to 10 carbons or, in some embodiments, from 1 to 8, 1 to 6, or 1 to 4 carbon atoms. Alkyl groups may be substituted or unsubstituted. Examples of straight chain alkyl groups include groups such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, tert-butyl, neopentyl, isopentyl, and 2,2-dimethylpropyl groups. Representative substituted alkyl groups may be substituted one or more times with substituents such as those listed above, and include without limitation haloalkyl (e.g., trifluoromethyl), hydroxyalkyl, thioalkyl, aminoalkyl, alkylaminoalkyl, dialkylaminoalkyl, alkoxyalkyl, carboxyalkyl, and the like.

Cycloalkyl groups include mono-, bi- or tricyclic alkyl groups having from 3 to 12 carbon atoms in the ring(s), or, in some embodiments, 3 to 10, 3 to 8, or 3 to 4, 5, or 6 carbon atoms. Cycloalkyl groups may be substituted or unsubstituted. Exemplary monocyclic cycloalkyl groups include, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 3 to 6, or 3 to 7. Bi-and tricyclic ring systems include both bridged cycloalkyl groups and fused rings, such as, but not limited to, bicyclo[2.1.1]hexane, adamantyl, decalinyl, and the like. Substituted cycloalkyl groups may be substituted one or more times with non-hydrogen and non-carbon groups as defined above. However, substituted cycloalkyl groups also include rings that are substituted with straight or branched chain alkyl groups as defined above. Representative substituted cycloalkyl groups may be mono-substituted or substituted more than once, such as, but not limited to, 2,2-, 2,3-, 2,4-2,5-or 2,6-disubstituted cyclohexyl groups, which may be substituted with substituents such as those listed above.

Cycloalkylalkyl groups are alkyl groups as defined above in which a hydrogen or carbon bond of an alkyl group is replaced with a bond to a cycloalkyl group as defined above. Cycloalkylalkyl groups may be substituted or unsubstituted. In some embodiments, cycloalkylalkyl groups have from 4 to 16 carbon atoms, 4 to 12 carbon atoms, and typically 4 to 10 carbon atoms. Substituted cycloalkylalkyl groups may be substituted at the alkyl, the cycloalkyl or both the alkyl and cycloalkyl portions of the group. Representative substituted cycloalkylalkyl groups may be mono-substituted or substituted more than once, such as, but not limited to, mono-, di- or tri-substituted with substituents such as those listed above.

Alkenyl groups include straight and branched chain alkyl groups as defined above, except that at least one double bond exists between two carbon atoms. Alkenyl groups may be substituted or unsubstituted. Alkenyl groups have from 2 to 12 carbon atoms, and typically from 2 to 10 carbons or, in some embodiments, from 2 to 8, 2 to 6, or 2 to 4 carbon atoms. In some embodiments, the alkenyl group has one, two, or three carbon-carbon double bonds. Examples include, but are not limited to vinyl, allyl, —CH═CH(CH₃), —CH═C(CH₃)₂, —C(CH₃)═CH₂, —C(CH₃)═CH(CH₃), —C(CH₂CH₃)═CH₂, among others. Representative substituted alkenyl groups may be mono-substituted or substituted more than once, such as, but not limited to, mono-, di- or tri-substituted with substituents such as those listed above.

Cycloalkenyl groups include cycloalkyl groups as defined above, having at least one double bond between two carbon atoms. Cycloalkenyl groups may be substituted or unsubstituted. In some embodiments the cycloalkenyl group may have one, two or three double bonds but does not include aromatic compounds. Cycloalkenyl groups have from 4 to 14 carbon atoms, or, in some embodiments, 5 to 14 carbon atoms, 5 to 10 carbon atoms, or even 5, 6, 7, or 8 carbon atoms. Examples of cycloalkenyl groups include cyclohexenyl, cyclopentenyl, cyclohexadienyl, cyclobutadienyl, and cyclopentadienyl.

Cycloalkenylalkyl groups are alkyl groups as defined above in which a hydrogen or carbon bond of the alkyl group is replaced with a bond to a cycloalkenyl group as defined above. Cycloalkenylalkyl groups may be substituted or unsubstituted. Substituted cycloalkenylalkyl groups may be substituted at the alkyl, the cycloalkenyl or both the alkyl and cycloalkenyl portions of the group. Representative substituted cycloalkenylalkyl groups may be substituted one or more times with substituents such as those listed above.

Alkynyl groups include straight and branched chain alkyl groups as defined above, except that at least one triple bond exists between two carbon atoms. Alkynyl groups may be substituted or unsubstituted. Alkynyl groups have from 2 to 12 carbon atoms, and typically from 2 to 10 carbons or, in some embodiments, from 2 to 8, 2 to 6, or 2 to 4 carbon atoms. In some embodiments, the alkynyl group has one, two, or three carbon-carbon triple bonds. Examples include, but are not limited to —C≡CH, —C≡CCH₃, —CH₂C≡CCH₃, and —C≡CCH₂CH(CH₂CH₃)₂, among others. Representative substituted alkynyl groups may be mono-substituted or substituted more than once, such as, but not limited to, mono-, di- or tri-substituted with substituents such as those listed above.

Aryl groups are cyclic aromatic hydrocarbons that do not contain heteroatoms. Aryl groups herein include monocyclic, bicyclic, and tricyclic ring systems. Aryl groups may be substituted or unsubstituted. Thus, aryl groups include, but are not limited to, phenyl, azulenyl, heptalenyl, biphenyl, fluorenyl, phenanthrenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. In some embodiments, the aryl groups are phenyl or naphthyl. The phrase “aryl groups” includes groups containing fused rings, such as fused aromatic-aliphatic ring systems (e.g., indanyl, tetrahydronaphthyl, and the like). Representative substituted aryl groups may be mono-substituted (e.g., tolyl) or substituted more than once. For example, monosubstituted aryl groups include, but are not limited to, 2-, 3—, 4-, 5-, or 6-substituted phenyl or naphthyl groups, which may be substituted with substituents such as those listed above.

Aralkyl groups are alkyl groups as defined above in which a hydrogen or carbon bond of an alkyl group is replaced with a bond to an aryl group as defined above. Aralkyl groups may be substituted or unsubstituted. In some embodiments, aralkyl groups contain 7 to 16 carbon atoms, 7 to 14 carbon atoms, or 7 to 10 carbon atoms. Substituted aralkyl groups may be substituted at the alkyl, the aryl or both the alkyl and aryl portions of the group. Representative aralkyl groups include but are not limited to benzyl and phenethyl groups and fused (cycloalkylaryl)alkyl groups such as 4-indanylethyl. Representative substituted aralkyl groups may be substituted one or more times with substituents such as those listed above.

Heterocyclyl groups include aromatic (also referred to as heteroaryl) and non-aromatic ring compounds containing 3 or more ring members, of which one or more is a heteroatom such as, but not limited to, N, O, and S. Heterocyclyl groups may be substituted or unsubstituted. In some embodiments, the heterocyclyl group contains 1, 2, 3 or 4 heteroatoms. In some embodiments, heterocyclyl groups include mono-, bi- and tricyclic rings having 3 to 16 ring members, whereas other such groups have 3 to 6, 3 to 10, 3 to 12, or 3 to 14 ring members. Heterocyclyl groups encompass aromatic, partially unsaturated, and saturated ring systems, such as, for example, imidazolyl, imidazolinyl and imidazolidinyl groups. The phrase “heterocyclyl group” includes fused ring species including those comprising fused aromatic and non-aromatic groups, such as, for example, benzotriazolyl, 2,3-dihydrobenzo[1,4]dioxinyl, and benzo[1,3]dioxolyl. The phrase also includes bridged polycyclic ring systems containing a heteroatom such as, but not limited to, quinuclidyl. The phrase includes heterocyclyl groups that have other groups, such as alkyl, oxo or halo groups, bonded to one of the ring members, referred to as “substituted heterocyclyl groups.” Heterocyclyl groups include, but are not limited to, aziridinyl, azetidinyl, pyrrolidinyl, imidazolidinyl, pyrazolidinyl, thiazolidinyl, tetrahydrothiophenyl, tetrahydrofuranyl, dioxolyl, furanyl, thiophenyl, pyrrolyl, pyrrolinyl, imidazolyl, imidazolinyl, pyrazolyl, pyrazolinyl, triazolyl, tetrazolyl, oxazolyl, isoxazolyl, thiazolyl, thiazolinyl, isothiazolyl, thiadiazolyl, oxadiazolyl, piperidyl, piperazinyl, morpholinyl, thiomorpholinyl, tetrahydropyranyl, tetrahydrothiopyranyl, oxathiane, dioxyl, dithianyl, pyranyl, pyridyl, pyrimidinyl, pyridazinyl, pyrazinyl, triazinyl, dihydropyridyl, dihydrodithiinyl, dihydrodithionyl, homopiperazinyl, quinuclidyl, indolyl, indolinyl, isoindolyl,azaindolyl (pyrrolopyridyl), indazolyl, indolizinyl, benzotriazolyl, benzimidazolyl, benzofuranyl, benzothiophenyl, benzthiazolyl, benzoxadiazolyl, benzoxazinyl, benzodithiinyl, benzoxathiinyl, benzothiazinyl, benzoxazolyl, benzothiazolyl, benzothiadiazolyl, benzo[1,3]dioxolyl, pyrazolopyridyl, imidazopyridyl (azabenzimidazolyl), triazolopyridyl, isoxazolopyridyl, purinyl, xanthinyl, adeninyl, guaninyl, quinolinyl, isoquinolinyl, quinolizinyl, quinoxalinyl, quinazolinyl, cinnolinyl, phthalazinyl, naphthyridinyl, pteridinyl, thianaphthyl, dihydrobenzothiazinyl, dihydrobenzofuranyl, dihydroindolyl, dihydrobenzodioxinyl, tetrahydroindolyl, tetrahydroindazolyl, tetrahydrobenzimidazolyl, tetrahydrobenzotriazolyl, tetrahydropyrrolopyridyl, tetrahydropyrazolopyridyl, tetrahydroimidazopyridyl, tetrahydrotriazolopyridyl, and tetrahydroquinolinyl groups. Representative substituted heterocyclyl groups may be mono-substituted or substituted more than once, such as, but not limited to, pyridyl or morpholinyl groups, which are 2-, 3-, 4-, 5-, or 6-substituted, or disubstituted with various substituents such as those listed above.

Heteroaryl groups are aromatic ring compounds containing 5 or more ring members, of which, one or more is a heteroatom such as, but not limited to, N, O, and S. Heteroaryl groups may be substituted or unsubstituted. Heteroaryl groups include, but are not limited to, groups such as pyrrolyl, pyrazolyl, triazolyl, tetrazolyl, oxazolyl, isoxazolyl, thiazolyl, pyridinyl, pyridazinyl, pyrimidinyl, pyrazinyl, thiophenyl, benzothiophenyl, furanyl, benzofuranyl, indolyl, azaindolyl (pyrrolopyridinyl), indazolyl, benzimidazolyl, imidazopyridinyl (azabenzimidazolyl), pyrazolopyridinyl, triazolopyridinyl, benzotriazolyl, benzoxazolyl, benzothiazolyl, benzothiadiazolyl, imidazopyridinyl, isoxazolopyridinyl, thianaphthyl, purinyl, xanthinyl, adeninyl, guaninyl, quinolinyl, isoquinolinyl, tetrahydroquinolinyl, quinoxalinyl, and quinazolinyl groups. Heteroaryl groups include fused ring compounds in which all rings are aromatic such as indolyl groups and include fused ring compounds in which only one of the rings is aromatic, such as 2,3-dihydro indolyl groups. Representative substituted heteroaryl groups may be substituted one or more times with various substituents such as those listed above.

Heterocyclylalkyl groups are alkyl groups as defined above in which a hydrogen or carbon bond of an alkyl group is replaced with a bond to a heterocyclyl group as defined above. Heterocyclylalkyl groups may be substituted or unsubstituted. Substituted heterocyclylalkyl groups may be substituted at the alkyl, the heterocyclyl or both the alkyl and heterocyclyl portions of the group. Representative heterocyclyl alkyl groups include, but are not limited to, morpholin-4-yl-ethyl, furan-2-yl-methyl, imidazol-4-yl-methyl, pyridin-3-yl-methyl, tetrahydrofuran-2-yl-ethyl, and indol-2-yl-propyl. Representative substituted heterocyclylalkyl groups may be substituted one or more times with substituents such as those listed above.

Heteroaralkyl groups are alkyl groups as defined above in which a hydrogen or carbon bond of an alkyl group is replaced with a bond to a heteroaryl group as defined above. Heteroaralkyl groups may be substituted or unsubstituted. Substituted heteroaralkyl groups may be substituted at the alkyl, the heteroaryl or both the alkyl and heteroaryl portions of the group. Representative substituted heteroaralkyl groups may be substituted one or more times with substituents such as those listed above.

Groups described herein having two or more points of attachment (i.e., divalent, trivalent, or polyvalent) within the compound of the present technology are designated by use of the suffix, “ene.” For example, divalent alkyl groups are alkylene groups, divalent aryl groups are arylene groups, divalent heteroaryl groups are divalent heteroarylene groups, and so forth. Substituted groups having a single point of attachment to the compound of the present technology are not referred to using the “ene” designation. Thus, e.g., chloroethyl is not referred to herein as chloroethylene.

Alkoxy groups are hydroxyl groups (—OH) in which the bond to the hydrogen atom is replaced by a bond to a carbon atom of a substituted or unsubstituted alkyl group as defined above. Alkoxy groups may be substituted or unsubstituted. Examples of linear alkoxy groups include but are not limited to methoxy, ethoxy, propoxy, butoxy, pentoxy, hexoxy, and the like. Examples of branched alkoxy groups include but are not limited to isopropoxy, sec-butoxy, tert-butoxy, isopentoxy, isohexoxy, and the like. Examples of cycloalkoxy groups include but are not limited to cyclopropyloxy, cyclobutyloxy, cyclopentyloxy, cyclohexyloxy, and the like. Representative substituted alkoxy groups may be substituted one or more times with substituents such as those listed above.

The terms “alkanoyl” and “alkanoyloxy” as used herein can refer, respectively, to —C(O)-alkyl groups and —O—C(O)-alkyl groups, each containing 2-5 carbon atoms. Similarly, “aryloyl” and “aryloyloxy” refer to —C(O)-aryl groups and —O—C(O)-aryl groups.

The terms “aryloxy” and “arylalkoxy” refer to, respectively, a substituted or unsubstituted aryl group bonded to an oxygen atom and a substituted or unsubstituted aralkyl group bonded to the oxygen atom at the alkyl. Examples include but are not limited to phenoxy, naphthyloxy, and benzyloxy. Representative substituted aryloxy and arylalkoxy groups may be substituted one or more times with substituents such as those listed above.

The term “carboxylate” as used herein refers to a —COOH group.

The term “ester” as used herein refers to —COOR⁷⁰ and —C(O)O-G groups. R⁷⁰ is a substituted or unsubstituted alkyl, cycloalkyl, alkenyl, alkynyl, aryl, aralkyl, heterocyclylalkyl or heterocyclyl group as defined herein. G is a carboxylate protecting group. Carboxylate protecting groups are well known to one of ordinary skill in the art. An extensive list of protecting groups for the carboxylate group functionality may be found in Protective Groups in Organic Synthesis, Greene, T. W.; Wuts, P. G. M., John Wiley & Sons, New York, NY, (3rd Edition, 1999) which can be added or removed using the procedures set forth therein and which is hereby incorporated by reference in its entirety and for any and all purposes as if fully set forth herein.

The term “amide” (or “amido”) includes C- and N-amide groups, i.e., —C(O)NR⁷¹R⁷², and —NR⁷¹C(O)R⁷² groups, respectively. R⁷¹ and R⁷² are independently hydrogen, or a substituted or unsubstituted alkyl, alkenyl, alkynyl, cycloalkyl, aryl, aralkyl, heterocyclylalkyl or heterocyclyl group as defined herein. Amido groups therefore include but are not limited to carbamoyl groups (—C(O)NH₂) and formamide groups (—NHC(O)H). In some embodiments, the amide is —NR⁷¹C(O)—(C₁₋₅ alkyl) and the group is termed “carbonylamino,” and in others the amide is —NHC(O)-alkyl and the group is termed “alkanoylamino.”

The term “nitrile” or “cyano” as used herein refers to the —CN group.

Urethane groups include N- and O-urethane groups, i.e., —NR⁷³C(O)OR⁷⁴ and —OC(O)NR⁷³R⁷⁴ groups, respectively. R⁷³ and R⁷⁴ are independently a substituted or unsubstituted alkyl, alkenyl, alkynyl, cycloalkyl, aryl, aralkyl, heterocyclylalkyl, or heterocyclyl group as defined herein. R⁷³ may also be H.

The term “amine” (or “amino”) as used herein refers to —NR⁷⁵R⁷⁶ groups, wherein R⁷⁵ and R⁷⁶ are independently hydrogen, or a substituted or unsubstituted alkyl, alkenyl, alkynyl, cycloalkyl, aryl, aralkyl, heterocyclylalkyl or heterocyclyl group as defined herein. In some embodiments, the amine is alkylamino, dialkylamino, arylamino, or alkylarylamino. In other embodiments, the amine is NH₂, methylamino, dimethylamino, ethylamino, diethylamino, propylamino, isopropylamino, phenylamino, or benzylamino.

The term “sulfonamido” includes S- and N-sulfonamide groups, i.e., —SO₂NR⁷⁸R⁷⁹ and —NR⁷⁸SO₂R⁷⁹ groups, respectively. R⁷⁸ and R⁷⁹ are independently hydrogen, or a substituted or unsubstituted alkyl, alkenyl, alkynyl, cycloalkyl, aryl, aralkyl, heterocyclylalkyl, or heterocyclyl group as defined herein. Sulfonamido groups therefore include but are not limited to sulfamoyl groups (—SO₂NH₂). In some embodiments herein, the sulfonamido is —NHSO₂-alkyl and is referred to as the “alkylsulfonylamino” group.

The term “thiol” refers to —SH groups, while “sulfides” include —SR⁸⁰ groups, “sulfoxides” include —S(O)R⁸¹ groups, “sulfones” include —SO₂R⁸² groups, and “sulfonyls” include —SO₂OR⁸³. R⁸⁰, R⁸¹, R⁸², and R⁸³ are each independently a substituted or unsubstituted alkyl, cycloalkyl, alkenyl, alkynyl, aryl aralkyl, heterocyclyl or heterocyclylalkyl group as defined herein. In some embodiments the sulfide is an alkylthio group, —S-alkyl. The term “sulfonic acid” as used herein refers to a —SO₃H group, and “sulfonate” as used herein refers to a —SO₃— group (a deprotonated form of sulfonic acid).

The term “urea” refers to —NR⁸⁴—C(O)—NR⁸⁵R⁸⁶ groups. R⁸⁴, R⁸⁵, and R⁸⁶ groups are independently hydrogen, or a substituted or unsubstituted alkyl, alkenyl, alkynyl, cycloalkyl, aryl, aralkyl, heterocyclyl, or heterocyclylalkyl group as defined herein.

The term “amidine” refers to —C(NR⁸⁷)NR⁸⁸R⁸⁹ and —NR⁸⁷C(NR⁸⁸)R⁸⁹, wherein R⁸⁷, R⁸⁸, and R⁸⁹ are each independently hydrogen, or a substituted or unsubstituted alkyl, cycloalkyl, alkenyl, alkynyl, aryl aralkyl, heterocyclyl or heterocyclylalkyl group as defined herein.

The term “guanidine” refers to —NR⁹⁰C(NR⁹¹)NR⁹²R⁹³, wherein R⁹⁰, R⁹¹, R⁹² and R⁹³ are each independently hydrogen, or a substituted or unsubstituted alkyl, cycloalkyl, alkenyl, alkynyl, aryl aralkyl, heterocyclyl or heterocyclylalkyl group as defined herein.

The term “enamine” refers to —C(R⁹⁴)═C(R⁹⁵)NR⁹⁶R⁹⁷ and —NR⁹⁴C(R⁹⁵)═C(R⁹⁶)R⁹⁷, wherein R⁹⁴, R⁹⁵, R⁹⁶ and R⁹⁷ are each independently hydrogen, a substituted or unsubstituted alkyl, cycloalkyl, alkenyl, alkynyl, aryl aralkyl, heterocyclyl or heterocyclylalkyl group as defined herein.

The term “halogen” or “halo” as used herein refers to bromine, chlorine, fluorine, or iodine. In some embodiments, the halogen is fluorine. In other embodiments, the halogen is chlorine or bromine.

The term “hydroxyl” as used herein can refer to —OH or its ionized form, —O—. A “hydroxyalkyl” group is a hydroxyl-substituted alkyl group, such as HO—CH₂—.

The term “imide” refers to —C(O)NR⁹⁸C(O)R⁹⁹, wherein R⁹⁸ and R⁹⁹ are each independently hydrogen, or a substituted or unsubstituted alkyl, cycloalkyl, alkenyl, alkynyl, aryl aralkyl, heterocyclyl or heterocyclylalkyl group as defined herein.

The term “imine” refers to —CR¹⁰⁰(NR¹⁰⁰) and —N(CR¹⁰⁰R₁₀₀) groups, wherein R¹⁰⁰ and R¹⁰¹ are each independently hydrogen or a substituted or unsubstituted alkyl, cycloalkyl, alkenyl, alkynyl, aryl aralkyl, heterocyclyl or heterocyclylalkyl group as defined herein, with the proviso that R¹⁰⁰ and R¹⁰¹ are not both simultaneously hydrogen.

The term “nitro” as used herein refers to an —NO₂ group.

The term “trifluoromethyl” as used herein refers to —CF₃.

The term “trifluoromethoxy” as used herein refers to —OCF₃.

The term “azido” refers to —N₃.

The term “trialkyl ammonium” refers to a —N(alkyl)₃ group. A trialkylammonium group is positively charged and thus typically has an associated anion, such as halogen anion.

The term “isocyano” refers to —NC.

The term “isothiocyano” refers to —NCS.

The term “pentafluorosulfanyl” refers to —SF₅.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 atoms refers to groups having 1, 2, or 3 atoms. Similarly, a group having 1-5 atoms refers to groups having 1, 2, 3, 4, or 5 atoms, and so forth.

As understood by one of ordinary skill in the art, “molecular weight” (also known as “relative molar mass”) is a dimensionless quantity but is converted to molar mass by multiplying by 1 gram/mole or by multiplying by 1 Da—for example, a compound with a weight-average molecular weight of 5,000 has a weight-average molar mass of 5,000 g/mol and a weight-average molar mass of 5,000 Da.

Those of skill in the art will appreciate that compounds of the present technology may exhibit the phenomena of tautomerism, conformational isomerism, geometric isomerism, and/or stereoisomerism. As the formula drawings within the specification and claims can represent only one of the possible tautomeric, conformational isomeric, stereochemical or geometric isomeric forms, it should be understood that the present technology encompasses any tautomeric, conformational isomeric, stereochemical and/or geometric isomeric forms of the compounds having one or more of the utilities described herein, as well as mixtures of these various different forms.

“Tautomers” refers to isomeric forms of a compound that are in equilibrium with each other. The presence and concentrations of the isomeric forms will depend on the environment the compound is found in and may be different depending upon, for example, whether the compound is a solid or is in an organic or aqueous solution. For example, in aqueous solution, quinazolinones may exhibit the following isomeric forms, which are referred to as tautomers of each other:

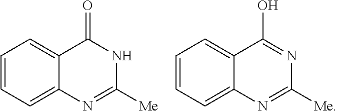

As another example, guanidines may exhibit the following isomeric forms in protic organic solution, also referred to as tautomers of each other:

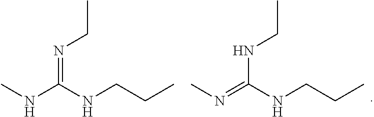

Because of the limits of representing compounds by structural formulas, it is to be understood that all chemical formulas of the compounds described herein represent all tautomeric forms of compounds and are within the scope of the present technology.

Stereoisomers of compounds (also known as optical isomers) include all chiral, diastereomeric, and racemic forms of a structure, unless the specific stereochemistry is expressly indicated. Thus, compounds used in the present technology include enriched or resolved optical isomers at any or all asymmetric atoms as are apparent from the depictions. Both racemic and diastereomeric mixtures, as well as the individual optical isomers can be isolated or synthesized so as to be substantially free of their enantiomeric or diastereomeric partners, and these stereoisomers are all within the scope of the present technology.

The compounds of the present technology may exist as solvates, especially hydrates. Hydrates may form during manufacture of the compounds or compositions comprising the compounds, or hydrates may form over time due to the hygroscopic nature of the compounds. Compounds of the present technology may exist as organic solvates as well, including DMF, ether, and alcohol solvates, among others. The identification and preparation of any particular solvate is within the skill of the ordinary artisan of synthetic organic chemistry.

### The Present Technology

Waterborne emulsion coating formulations (including paint formulations) are widely used on exterior surfaces due to their generally good weatherability, low VOC content, and overall cost-effective performance. Colloidal silica particles have been used in these coating formulations, but, especially in aqueous systems that contain latex binder particles, various components present in the composition such as surfactants, coalescent agents, defoamers, thickeners, etc., may undesirably interact with unmodified colloidal silica and affect the stability of the colloidal system.

Furthermore, fouling of exterior coating surfaces by dirt continues to be a problem, particularly in waterborne coatings. Recent developments in coatings have seen the rise in popularity of formulations with lower volatile organic compounds (VOCs). In comparison to solventborne coatings, waterborne coatings with low VOC content tend to be more susceptible to dirt pickup on exterior surfaces over time, reducing the visual appeal of the coating.

There is an ongoing effort to improving the DPUR of coatings. One of the approaches include the incorporation of surface modified colloidal silica particles in coating formulations. U.S. Pat. Publ. 2010/0288963 discloses the synthesis and resulting coating compositions of colloidal silica particles including aldehyde containing groups, where the modified colloidal silica particles improve the DPUR of the coatings. Organosilane functionalized colloidal silica has been reacted with monomers in the presence of an initiator and a protective colloid in U.S. Pat. Publ. 2021/0332252, where coating formulations including these materials result in coatings with improved stain resistance.

Furthermore, waterborne coatings tend to lack corrosion prevention properties. Direct-to-metal (DTM) coatings are conventionally used as weatherable coatings to protect metal surfaces. Still, DTM coatings are typically considered to perform more poorly than systems with a primer and topcoat, and solventborne coating systems. For example, U.S. Pat. No. 9,650,535 mentions the improved stability of waterborne coating dispersions with surface modified colloidal particles, and U.S. Pat. Publ. 2021/0332252 also mentions their use in coatings to improve adhesion and water resistance, but neither mention of improved corrosion resistance when applied to metal substrates.

The present technology addresses the above-discussed deficiencies in waterborne coatings—including in relation to improved dirt pickup resistance (DPUR) and/or corrosion prevention performance. Thus, in an aspect, the present technology provides a composition that includes water, a binder, and a colloidal silica functionalized with anionic molecules and/or a colloidal silica functionalized with neutral molecules. The composition may be a coating composition, a paint composition, a DTM coating composition, and the like. The compositions may provide improved DPUR and/or corrosion prevention performance.

The colloidal silica functionalized with anionic molecules may include silica particles (where each silica particle includes a surface) and a structural unit according to Formula I, a structural unit according to Formula II, a structural unit according to Formula III, a structural unit according to Formula IV, or a structural unit according to Formula V

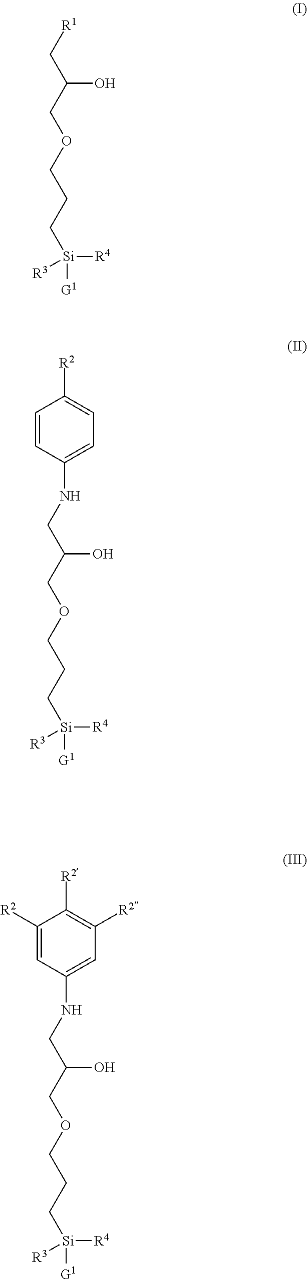

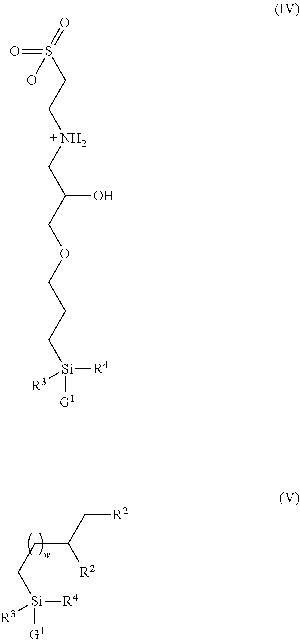

where
   R¹ is —S—(CH₂)ₙR² where n is 1, 2, 3, 4, 5, or 6;
   R² is independently at each occurrence —SO₃Y¹, —SO₃H, —SO₃—, —CO₂Y², —CO₂H, or —CO₂—;
   R^{2′} and R^{2″} are each independently H, —SO₃Y¹, —SO₃H, —SO₃, —CO₂Y², —CO₂H, or —CO₂—;
   R³ is hydroxyl, alkoxy, aryloxy, or G²;
   R⁴ is hydroxyl, alkoxy, aryloxy, or G³;
   G¹, G², and G³ are each independently an oxygen atom of the surface of the silica particle, where G¹, G², and G³ are not the same oxygen atom;
   w is 0, 1, 2, 3, 4, 5, or 6;
   Y¹ is independently at each occurrence a cation; and
   Y² is independently at each occurrence a cation.

The colloidal silica functionalized with neutral molecules may include silica particles (where each silica particle includes a surface) and a structural unit according to Formula VI

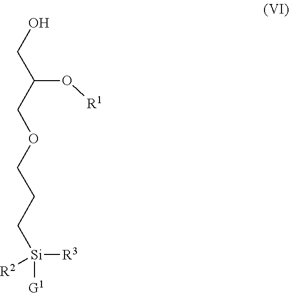

where
   R¹ is
   —CH₂(CHOH)ₓCH₂OH where x is 1, 2, 3, 4, 5, or 6,

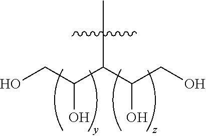

where y+z is 0, 1, 2, 3, 4, or 5,

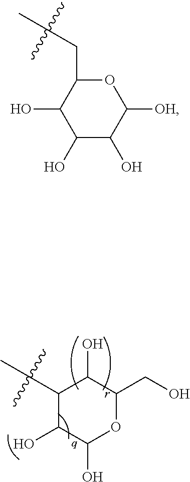

where q+r is 2;

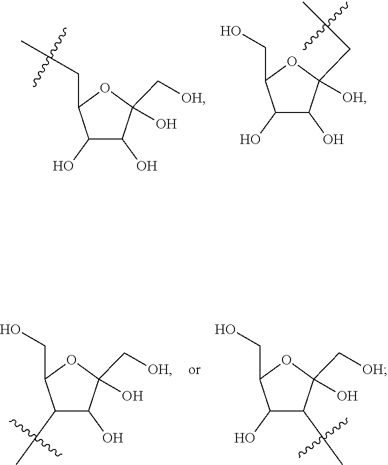 [SMILES: *CC1OC(O)(CO)C(O)C1O ; *CC1(O)OC(CO)C(O)C1O ; *C1C(CO)OC(O)(CO)C1O ; *C1C(O)C(CO)OC1(O)CO]

R² is hydroxyl, alkoxy, aryloxy, or G²
R³ is hydroxyl, alkoxy, aryloxy, or G³; and
G¹, G², and G³ are each independently an oxygen atom of the surface of the silica particle, where G¹, G², and G³ are not the same oxygen atom.

In any embodiment herein, the silica particles may have a median diameter as determined by dynamic light scattering or disc centrifuge analysis of about 1 nm to about 100 nm (D50 on a volume basis). Thus, the median diameter of the silica particles as determined by dynamic light scattering may be about 1 nm, about 5 nm, about 10 nm, about 15 nm, about 20 nm, about 25 nm, about 30 nm, about 35 nm, about 40 nm, about 45 nm, about 50 nm, about 55 nm, about 60 nm, about 65 nm, about 70 nm, about 75 nm, about 80 nm, about 85 nm, about 90 nm, about 95 nm, about 100 nm, or any range including and/or in-between any two of these values.

In any embodiment herein, the silica particles may have a Sears surface area of about 25 m²/g to about 1,200 m²/g. See Sears, “Determination of Specific Area of Colloidal Silica by Titration with Sodium Hydroxide” Analytical Chemistry 1956, 28(12), 1981-1983 https://doi.org/10.1021/ac60120a048. Thus, the silica particles of any embodiment herein may have a Sears surface area of about 25 m²/g, 26 m²/g, 27 m²/g, 28 m²/g, 29 m²/g, 30 m²/g, 35 m²/g, 40 m²/g, 45 m²/g, 50 m²/g, 55 m²/g, 60 m²/g, 70 m²/g, 80 m²/g, 90 m²/g, 100 m²/g, 150 m²/g, 200 m²/g, 250 m²/g, 300 m²/g, 350 m²/g, 400 m²/g, 450 m²/g, 500 m²/g, 550 m²/g, 600 m²/g, 650 m²/g, 700 m²/g, 750 m²/g, 800 m²/g, 850 m²/g, 900 m²/g, 950 m²/g, 1,000 m²/g, 1,100 m²/g, 1,200 m²/g, or any range including and/or in-between any two of these values.

The composition of any embodiment herein may include a number of structural units according to Formula I, structural units according to Formula II, structural units according to Formula III, structural units according to Formula IV, structural units according to Formula V, and/or structural units according to Formula VI per nm² surface area of about 0.8 to about 3.5.

Accordingly, the composition of any embodiment herein may include a number of structural units according to Formula I, structural units according to Formula II, structural units according to Formula III, structural units according to Formula IV, structural units according to Formula V, and/or structural units according to Formula VI per nm² surface area of about 0.8, about 0.9, about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, or any range including and/or in-between any two of these values.

The functionalized colloidal silica of any embodiment herein may include a mass percentage composition of carbon as determined by elemental analysis of about 1%, 2%, 3%, 4%, 5%, 6%, 7%, 8%, 9%, 10%, or any range including and/or between any two of these values.

The functionalized colloidal silica of any embodiment including structural units with sulfur may include a percentage composition of sulfur as determined by elemental analysis of about 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, or any range including and/or between any two of these values.

The functionalized colloidal silica of any embodiment including structural units with nitrogen may include a percentage composition of nitrogen as determined by elemental analysis of about 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, or any range including and/or between any two of these values.

In any embodiment herein, it may be that the composition includes a colloidal silica functionalized with anionic molecules having a structural unit according to Formula I and R¹ is —(CH₂)₂SO₃Na and/or R¹ is —(CH₂)₃SO₃Na. In any embodiment herein, it may be that the composition includes a colloidal silica functionalized with anionic molecules having a structural unit according to Formula II and R² is —SO₃Na. In any embodiment herein, it may be that the composition includes a colloidal silica functionalized with anionic molecules having a structural unit according to Formula III where R² is —SO₃Na and R^{2′} and R^{2″} are each independently H. In any embodiment herein, it may be that the composition includes a colloidal silica functionalized with anionic molecules having a structural unit according to Formula III where R² is —CO₂H, R^{2′} is H, and R^{2″} is —CO₂H. In any embodiment herein, it may be that the composition includes a colloidal silica functionalized with anionic molecules having a structural unit according to Formula III where R² is —CO₂H, R^{2′} is —CO₂H, and R^{2″} is H. In any embodiment herein, it may be that the composition includes a colloidal silica functionalized with anionic molecules having a structural unit according to Formula III where R² is —CO₂H, R^{2′} is —CO₂H, and R^{2″} is —CO₂H. In any embodiment herein, it may be that the composition includes a colloidal silica functionalized with anionic molecules having a structural unit according to Formula IV. In any embodiment herein, it may be that R³ is hydroxyl, methoxy, ethoxy, propoxy, phenoxy, or G². In any embodiment herein, it may be that it may be that R⁴ is hydroxyl, methoxy, ethoxy, propoxy, phenoxy, or G³. In any embodiment herein, it may be that R³ is G². In any embodiment herein, it may be that R⁴ is hydroxyl. In any embodiment herein, the silica particles may include at least one structural unit according to Formula Ia or Ib

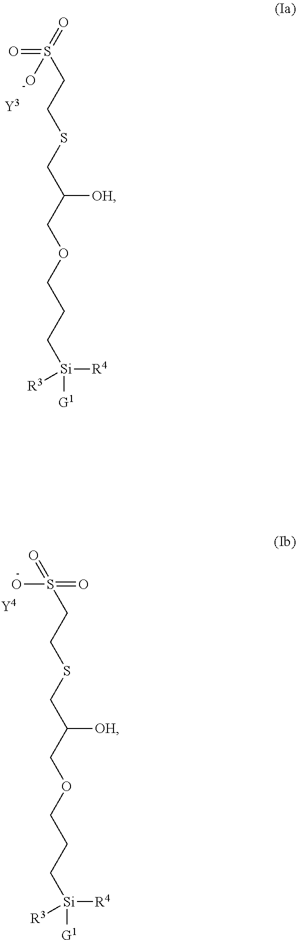

where Y³ and Y⁴ are independently at each occurrence a cation.

In any embodiment herein, Y¹, Y², Y³, and Y⁴ may independently at each occurrence be, for example, NH₄⁺, Na⁺, Li⁺, K⁺, Ag⁺, Ca²⁺, Mg²⁺, or Zn²⁺.

In any embodiment herein, it may be that the silica particles further include at least one structural unit according to Formula VII

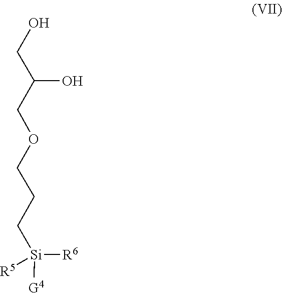

wherein
   R⁵ is hydroxyl, alkoxy, aryloxy, or G⁵.
   R⁶ is hydroxyl, alkoxy, aryloxy, or G⁶.
   G⁴, G⁵, and G⁶ are each independently an oxygen atom of the surface of the silica particle, where G⁴, G⁵, and G⁶ are not the same oxygen atom.

In any embodiment herein, it may be that R⁴ is hydroxyl, methoxy, ethoxy, propoxy, phenoxy, or G⁵. In any embodiment herein, it may be that it may be that R⁵ is hydroxyl, methoxy, ethoxy, propoxy, phenoxy, or G⁶.

In any embodiment herein, it may be that the composition includes a colloidal silica functionalized with neutral molecules having a structural unit according to Formula VI, where R¹ is —CH₂(CHOH)ₓCH₂OH where x is 1, 2, 3, 4, 5, or 6,

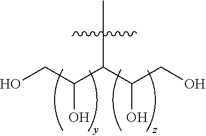

where y+z is 0, 1, 2, 3, 4, or 5,

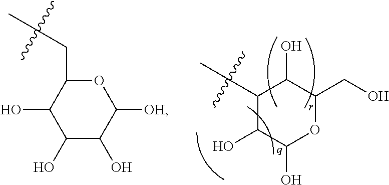

where q+r is 2;

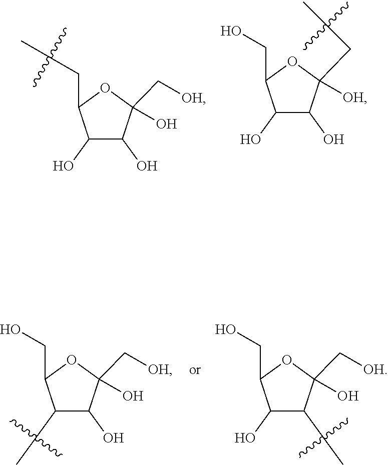 [SMILES: *CC1OC(O)(CO)C(O)C1O ; *CC1(O)OC(CO)C(O)C1O ; *C1C(CO)OC(O)(CO)C1O ; *C1C(O)C(CO)OC1(O)CO]

Thus, in any embodiment herein where the composition includes a colloidal silica functionalized with neutral molecules having a structural unit according to Formula VI, R¹ may be —CH₂(CHOH)ₓCH₂OH where x is 1, 2, 3, 4, 5, or 6—for example, x may be 1 (arising from glycerol), x may be 2 (e.g., arising from erythritol), x may be 3 (e.g., arising from xylitol), x may be 4 (e.g., arising from sorbitol or mannitol), or x may be 5. In any embodiment herein where the composition includes a colloidal silica functionalized with neutral molecules having a structural unit according to Formula VI, R¹ may alternatively be

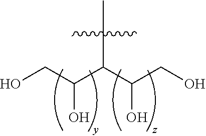

Y z where y+z is 0, 1, 2, 3, 4, or 5 —for example, y may be 0 and z may be 0, y may be 0 and z may be 1, 2, 3, 4, or 5, y may be 1 and z may be 1, 2, 3, or 4, or y may be 2 and z may be 1, 2, or 3. In any embodiment herein where the composition includes a colloidal silica functionalized with neutral molecules having a structural unit according to Formula VI, R¹ may alternatively be

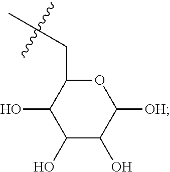

thus, for example, R¹ may be

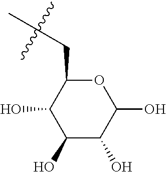 [SMILES: *C[C@H]1OC(O)[C@H](O)[C@@H](O)[C@@H]1O]

(e.g., arising from D-glucose),

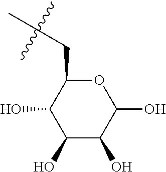 [SMILES: *C[C@H]1OC(O)[C@@H](O)[C@@H](O)[C@@H]1O]

(e.g., arising from D-mannose), or

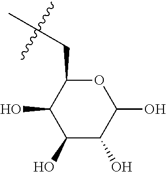 [SMILES: *C[C@H]1OC(O)[C@H](O)[C@@H](O)[C@H]1O]

(e.g., arising from D-galactose). In any embodiment herein where the composition includes a colloidal silica functionalized with neutral molecules having a structural unit according to Formula VI, R¹ may alternatively be

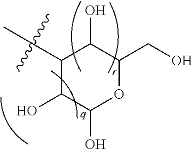

where q+r is 2—for example, q may be 0 and r may be 2, q may be 1 and r may be 1, or q may be 2 and r may be 0. In any embodiment herein where the composition includes a colloidal silica functionalized with neutral molecules having a structural unit according to Formula VI, R¹ may alternatively be

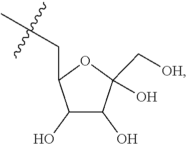

such as

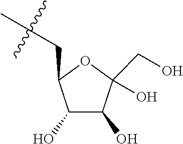 [SMILES: *C[C@H]1OC(O)(CO)[C@@H](O)[C@@H]1O]

(e.g., arising from D-fructose). In any embodiment herein where the composition includes a colloidal silica functionalized with neutral molecules having a structural unit according to Formula VI, R¹ may alternatively be

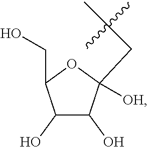

such as

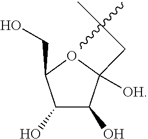 [SMILES: *CC1(O)O[C@H](CO)[C@@H](O)[C@@H]1O]

R¹ may alternatively be

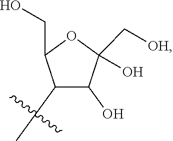 [SMILES: *C1C(CO)OC(O)(CO)C1O]

such as

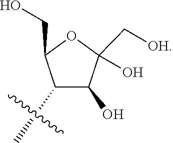

R¹ may alternatively be

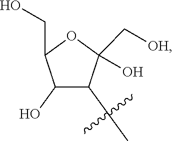 [SMILES: *C1C(O)C(CO)OC1(O)CO]

such as

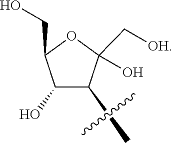

In any embodiment herein where the composition includes a colloidal silica functionalized with neutral molecules having a structural unit according to Formula VI, it may be that R² is hydroxyl, methoxy, ethoxy, propoxy, phenoxy, or G². In any embodiment herein where the composition includes a colloidal silica functionalized with neutral molecules having a structural unit according to Formula VI, it may be that it may be that R³ is hydroxyl, methoxy, ethoxy, propoxy, phenoxy, or G³. In any embodiment herein, it may be that R² is G². In any embodiment herein where the composition includes a colloidal silica functionalized with neutral molecules having a structural unit according to Formula VI, it may be that R³ is hydroxyl.

In any embodiment herein where the composition includes a colloidal silica functionalized with neutral molecules having a structural unit according to Formula VI, the silica particles may include at least one structural unit according to Formula VIa, VIb, VIc, VId, or VIe

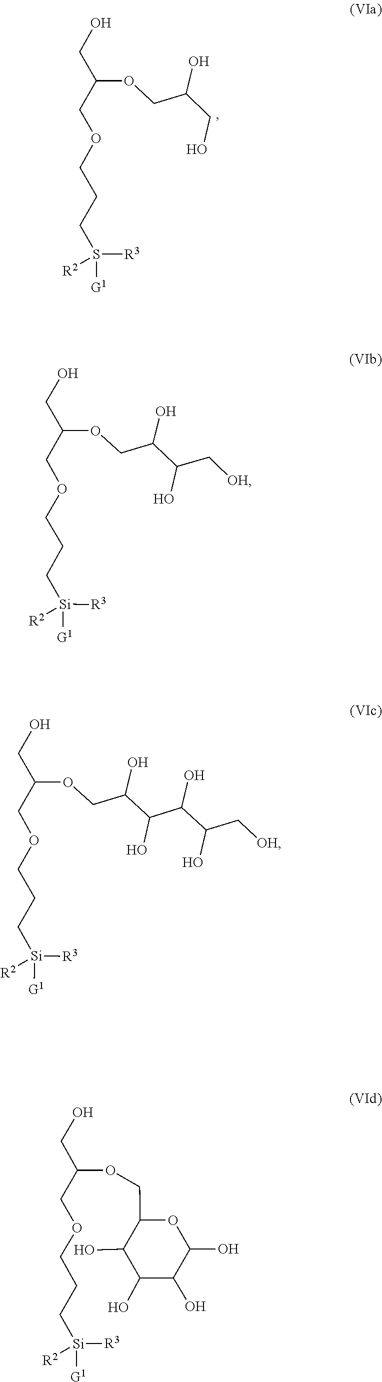

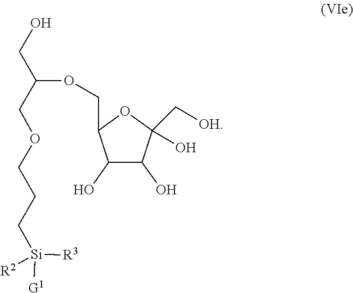

In any embodiment herein, it may be that the silica particles further include at least one

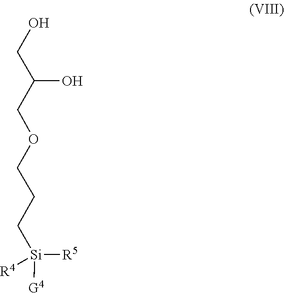

where
   R⁴ is hydroxyl, alkoxy, aryloxy, or G⁵;
   R¹ is hydroxyl, alkoxy, aryloxy, or G⁶;
   G⁴, G⁵, and G⁶ are each independently an oxygen atom of the surface of the silica particle, where G⁴, G⁵, and G⁶ are not the same oxygen atom.

In any embodiment herein where the composition includes a colloidal silica functionalized with neutral molecules having a structural unit according to Formula VI, it may be that R⁴ is hydroxyl, methoxy, ethoxy, propoxy, phenoxy, or G⁵. In any embodiment herein where the composition includes a colloidal silica functionalized with neutral molecules having a structural unit according to Formula VI, it may be that it may be that R⁵ is hydroxyl, methoxy, ethoxy, propoxy, phenoxy, or G⁶.

The composition of any embodiment herein may include about 0.1 wt. % to about 20 wt. % of the functionalized colloidal silica. Thus, in any embodiment herein the composition may include the functionalized colloidal silica in an amount of about 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1 wt. %, 2 wt. %, 3 wt. %, 4 wt. %, 5 wt. %, 6 wt. %, 7 wt. %, 8 wt. %, 9 wt. %, 10 wt. %, 15 wt. %, 20 wt. %, or any range including and/or in-between any two of these values. For example, in any embodiment herein the composition may include the functionalized colloidal silica in an amount of about 0.1 wt. % to about 5 wt. %, about 4 wt. % to about 20 wt. %, or about 10 wt. % to about 20 wt. %. For example, in any embodiment where the composition includes colloidal silica functionalized with anionic molecules, the composition may include about 0.1 wt. % to about 10 wt. % or about 2 wt. % to about 4 wt. % of the colloidal silica functionalized with anionic molecules. For example, in any embodiment where the composition includes colloidal silica functionalized with neutral molecules, the composition may include about 4 wt. % to about 20 wt. % of the colloidal silica functionalized with neutral molecules.

Water may be present in the composition in an amount of about 10 wt. % to about 90 wt. %. In any embodiment, the amount of water in the composition may be that amount of water that makes up the balance of the weight percentage of the composition.

The binder in the composition may include an acrylic latex. In any embodiment herein, the binder may include styrene acrylic, styrene butadiene, vinyl acrylic, vinyl acetate homopolymers, polyurethane, a modified polyurethane, a polyester, a chlorinated polymer and/or copolymers and/or copolymer latexes, or a combination of any two or more thereof.

The composition of any embodiment herein may include about 5 wt. % to about 80 wt. % of the binder. Thus, in any embodiment herein the composition may include the binder in an amount of about 10 wt. % to about 50 wt. %, about 20 wt. % to about 40 wt. %, about 25 wt. % to about 35 wt. %, about 50 wt. % to about 80 wt. %, about 60 wt. % to about 80 wt. %, or about 70 wt. % to about 80 wt. %.

The composition of any embodiment herein may further include additional coating components. Additional coating components may include a pigment, a neutralizer, a matting agent, a biocide, a coalescent, a pigment dispersant, a defoamer, a wetting agent, a nonionic surfactant, a rheology modifier, or a combination of any two or more thereof. In any embodiment, the composition may further include a pigment, a neutralizer, a biocide, a coalescent, a pigment dispersant, a defoamer, a wetting agent, a nonionic surfactant, and a rheology modifier.

The pigment may be any inorganic or organic pigment. The pigment may be a color-imparting and opaque finely divided solid. Examples of inorganic pigments are metal oxides, including titanium dioxide, iron oxide or zinc oxide, in particular titanium dioxide. Examples of organic pigments are phthalocyanines, including phthalocyanine blue, or diaryl pigments, azo pigments or quinacridone pigments.

The composition may comprise the pigment in an amount of about 2 wt. % to about 30 wt. %. Thus, in any embodiment herein the composition may include the pigment in an amount of about 10 wt. % to about 20 wt. % or about 15 wt. % to about 20 wt. %.

The composition of any embodiment herein may further include a matting agent. A “matting agent” of any embodiment herein refer to any inorganic or organic particles that provide a matting effect. In any embodiment herein including a matting agent, the matting agent may include a silica (e.g., silicon dioxide), nepheline syenite, a clay (e.g., aluminum silicate), talc (e.g., magnesium silicate), a calcined kaolin clay, a delaminated kaolin clay, a silicate, a calcium carbonate (e.g., ground calcium carbonate and/or precipitated calcium carbonate), an aluminum oxide, a barytes (e.g., barium sulfate), a gypsum (i.e., a hydrated calcium sulphate), a mica, a feldspar, a polyurea, a polyacrylate, a wax, a polymethylmethacrylate, a polyethylene, a polytetrafluoroethene, or a mixture of any two or more thereof. Suitable commercially available matting agents include, for example, SYLOID® Silica matting agent available from Grace, ACEMATT® silica matting agents available from Evonik, MINEX® nepheline syenites by Unimin, Celite® and Diafil® diatomecious earth materials from Imerys, DEUTERON™ MK polymethyl urea matting agent available from Deuteron.

In any embodiment herein including a matting agent, the composition may include the matting agent in an amount of about 0.1 wt. % to about 45 wt. %. Thus, in any embodiment herein the composition may include the matting agent in an amount of about 5 wt. % to about 40 wt. %, about 15 wt. % t about 25 wt. %, or about 18 wt. % to about 24 wt. %.

The neutralizer may be used to keep the final pH value of the composition at a predetermined pH. The predetermined pH may be higher than 8.5, for example 8.5 to 11, or 9.0 to 10. The neutralizer may be an organic amine or water-soluble inorganic base. For example, the neutralizer may include, but is not limited to N-methylmorpholine, triethylamine, dimethylethanolamine, dimethylisopropanolamine, methyl-diethanolamine, triethanolamine or ethyl-di-isopropylamine, diethyl-ethanolamine, butanolamine, morpholine, 2-aminomethyl-2-methyl-propanol (AMP), isophoronediamine, or ammonium hydroxide (NH₄OH).

The composition may comprise the neutralizer in an amount of about 0.001 wt. % to about 5 wt. %. Thus, in any embodiment herein the composition may include the neutralizer in an amount of about 0.01 wt. % to about 2 wt. %, about 0.05 wt. % to about 1 wt. %, or about 0.1 wt. % to about 0.2 wt. %.

The biocide may be used to prevent or deter biofouling of the composition. The biocide may be an in-can biocide, a dry film biocide, or a combination thereof. Examples include, but not limited to, benzisothiazolinone, methylisothiazolinone, products sold under the tradename KATHON™ and SKANE™ by Dow, Nuosept® 95 and Polyphase products by Troy Corp, Proxel® and Omacide® by Lonza.

The composition may include the biocide in an amount of about 0.01 wt. % to about 5 wt. %. Thus, in any embodiment herein the composition may include the biocide in an amount of about 0.01 wt. % to about 2 wt. %, about 0.05 wt. % to about 1 wt. %, or about 0.1 wt. % to about 0.2 wt. %.

The composition may include a pigment dispersant to disperse the pigment in the composition. For example, the pigment dispersant may be a commercial product from Dow Chemical containing ammonium salt of an acrylic acid copolymer. Exemplary pigment dispersants include, but are not limited to, 2-amino-2-methyl-1-propanol, polyacid dispersants, hydrophilic copolymer dispersants, hydrophobic copolymers dispersants such as Tamol™ 1124, Tamol™ 165A, or Tamol™ 851, and the like, available from Dow. Dispersing agents supplied by BASF under the tradename of Dispex® are also suitable. In any embodiment herein including a pigment dispersant, a single or a combination of any two or more dispersants may be included.

The composition may include the pigment dispersant in an amount of about 0.1 wt. % to about 5 wt. %. Thus, in any embodiment herein the composition may include the pigment dispersant in an amount of about 0.5 wt. % to about 4 wt. %, or about 1 wt. % to about 2 wt. %.

The composition may include a defoamer. A “defoamer” as used herein refers to a chemical additive that reduces and hinders the formation of foam. Defoamers may be silicone-based defoamers, mineral oil-based defoamers, ethylene oxide/propylene oxide-based defoamers, alkyl polyacrylates, or mixtures thereof. Suitable commercially available defoamers include, for example, TEGO® Airex 902 W, TEGO® Foamex 1488, TEGO® Foamex 810 polyether siloxane copolymer emulsions available from Evonik, BYK-024 silicone deformer available from BYK, Drew™ or Drewplus™ from Ashland, Foamstar® from BASF, DOWSIL™ 8590 from Dow or mixtures thereof.

The composition may include the defoamer in an amount of about 0.01 wt. % to about 5 wt. %. Thus, in any embodiment herein the composition may include the defoamer in an amount of about 0.01 wt. % to about 2 wt. %, about 0.05 wt. % to about 1 wt. %, or about 0.1 wt. % to about 0.2 wt. %.

The composition may include a wetting agent. A “wetting agent” as used herein refers to a chemical additive that reduces the surface tension of a coating composition, causing the coating composition to more easily spread across or penetrate the surface of a substrate. A wetting agent may include an anionic wetting agent, a zwitterionic wetting agent, a non-ionic wetting agent, or a combination of any two or more thereof. Examples of nonionic surfactants may include polyoxyethylene alkyl ethers, polyoxyethylene alkyl phenyl ethers, polyoxyethylene fatty acid esters, sorbitan fatty acid esters, polyoxyethylene sorbitan fatty acid esters, polyether-modified siloxanes, or a combination of any two or more thereof. Suitable commercially available wetting agents include, for example, SURFYNOL™ 104 nonionic wetting agent based on an actacetylenic diol available from Air Products, BYK™-346, BYK-348 and BYK-349 polyether-modified siloxanes available from BYK, TRITON™ or TERGITOL™ products from Dow, or a combinatino of any two or more thereof.

The composition may include the wetting agent in an amount of about 0.01 wt. % to about 5 wt. %. Thus, in any embodiment herein the composition may include the wetting agent in an amount of about 0.01 wt. % to about 2 wt. %, about 0.05 wt. % to about 1 wt. %, or about 0.1 wt. % to about 0.3 wt. %.

The composition may include a coalescent. Coalescents may include, for example, 2,2,4-trimethyl-1,3-pentanediol monoisobutyrate, TEXANOL™, butyl carbinol, hexylene glycol, ethylene glycol monobutyl ether, adipic, phthalic and benzoic acid esters of propane diol and propylene glycol ether, or a combination of two or more thereof.

The composition may include the coalescent in an amount of about 0.01 wt. % to about 5 wt. %. Thus, in any embodiment herein the composition may include the coalescent in an amount of about 0.01 wt. % to about 2 wt. %, about 0.05 wt. % to about 1 wt. %, or about 0.1 wt. % to about 0.3 wt. %.

The composition may include a rheology modifier. Examples of rheology modifiers include, but are not limited to, hydrophobically modified urethane rheology modifiers, hydrophobically modified polyether rheology modifiers, alkali swellable (or soluble) emulsions, hydrophobically modified alkali swellable (or soluble) emulsions, cellulosic rheology modifiers, hydrophobically modified cellulosic rheology modifiers, or a combination of any two or more thereof. Further examples are those rheology modifiers available from Dow under the trade name Acrysol™, such as RM-8W, RM-825, RM-3000, RM-5000, RM-2020 NPR, RM-5, TT-935, and Natrasol™, Natrasol Plus™ and Aquaflow™ from Ashland, and Polyphobe® from Arkema, and Rheovis from BASF.

The composition may include the rheology modifier in an amount of about 0.01 wt. % to about 10 wt. %. Thus, in any embodiment herein the composition may include the defoamer in an amount of about 0.01 wt. % to about 5 wt. %, about 0.05 wt. % to about 5 wt. %, or about 0.1 wt. % to about 0.2 wt. %.

In any embodiment herein, the coating composition may exhibit enhanced dirt pick-up resistance, such as by exhibiting a “Dirt Pickup Resistance Rating” (“DPUR Rating”) of 2 to 3, where a DPUR Rating is determined according to the following protocol:
a dirt simulant is made by dispersing carbon black (Darco Activated Carbon G-60) at 0.34 wt. % in water in the presence of nonionic surfactant TRITON™ CF-10 at a concentration of 0.10 wt. %;
a few drops of this dispersion is applied to a coating (prepared after applying a coating composition to a surface and allowing to dry for 24 hours at about 22° C.) and allowed to dry at room temperature (e.g., 18° C. to about 25° C.) for five hours;
whereafter the coating is exposed to 60° C. and 100% relative humidity for 48 hours to simulate accelerated aging;
after the accelerated aging, the coating is allowed to dry at room temperature for 5 hours and gently rinsed with tap water until all the loose carbon deposits are removed; and
the rinsed coatings were allowed to dry at room temperature and evaluated visually to assign a DPUR Rating: a rating of 1 means dark carbon spots remained and indicates poor dirt pick-up resistance; a rating of 2 means gray carbon spots remain, and indicates moderate dirt pick-up resistance; and rating of 3 means light gray carbon spots remained, and indicates good dirt pick-up resistance.

In any embodiment herein, the coating composition may exhibit a DPUR Rating of 3.

In any embodiment herein, the coating composition may exhibit enhanced corrosion resistance, such as determined by ASTM B117 salt spray protocols (see Example 6 herein) and according to the following protocol:
test coupons including HDG steel are coated by drawdown of the a coating composition with a #75 wire-wound rod to yield a coating with a dry film thickness (DFT) of 50 μm after 3 days of drying at ambient temperature;
such test coupons are then allowed to dry for at least 7 days and are scribed with a carbide tipped scribe pen in an X pattern;
the edges of the test coupons are then taped, and the test coupons placed in salt spray (per ASTM B117) for a total duration of 1000 hours; and
following the salt spray exposure duration, the coatings are rated on a scale of 0 to 5—with 0 being worst and 5 being best on adhesion loss at scribe and corrosion at scribe—in accordance with Table A below:

TABLE A
Corrosion Evaluation Rating System:

| Rating | 5 | 4 | 3 | 2 | 1 | 0 |
|---|---|---|---|---|---|---|
| Adhesion loss at | No change | Average | Average | Average | Average | Average |
| scribe (not grading | from initial | delamination | delamination | delamination | delamination | delamination |
| scribe less than 10 | | width <1 mm | width <3 mm | width <6 mm | width <8 mm | width 8 mm |
| mm from the end) | | | | | | of more |
| | | | | | | from scribe |
| Corrosion at scribe | No change | Some gray and | Gray and white | Gray and white | Red and | Red |
| | from initial | white corrosion | corrosion on | corrosion 50% | gray/white | corrosion on |
| | | on <10% of | 10%-50% of | to 100% of | corrosion on 50%- | 100% of |
| | | scribe | scribe | scribe | 100% of scribe | scribe |

In any embodiment herein, the coating composition may exhibit an adhesion loss at scribe in accordance with the above-described protocols of 2, 3, 4, 5, or any range including and/or in-between any two of these values. In any embodiment herein, the coating composition may exhibit a corrosion at scribe in accordance with the above-described protocols of 2, 3, 4, 5, or any range including and/or in-between any two of these values.

In any embodiment herein, the coating composition may exhibit enhanced ICI viscosity stability and/or enhanced KU viscosity stability. In any embodiment herein, where the coating composition has a “fresh” viscosity as measured by a Brookfield rheometer at a temperature of 25° C. of less than 1,000 cP (where a “fresh” viscosity measurement is performed after preparing the coating composition and allowing the coating composition to rest for 24 hours at 25° C.), the coating composition may exhibit a change in ICI viscosity value of less than 25% on an absolute basis upon aging at 52° C. for 4 weeks (where ICI viscosity values are measured using a CAP 2000+ viscometer made by BYK and equipped with Number 1 spindle at 900 rpm and at 25° C.) and/or may exhibit a change in KU viscosity value of less than 25% on an absolute basis upon aging at 52° C. for 4 weeks (where KU viscosity was measured using a KU-2 viscometer made by BYK at a temperature of 25° C.), as calculated per Eq. 1 below:

$$\% Change = \frac{( Fresh - Aged )}{Fresh} \qquad Eq . 1$$

In any embodiment herein, the coating composition may exhibit enhanced rheological stability. In any embodiment herein, where the coating composition has a “fresh” viscosity as measured by a Brookfield rheometer at a temperature of 25° C. of less than 1,000 cP (where a “fresh” viscosity measurement is performed after preparing the coating composition and allowing the coating composition to rest for 24 hours at 25° C.), the coating composition may exhibit a viscosity of less than 1,000 cP after aging at 50° C. for 4 weeks (as measured by a Brookfield rheometer and at a temperature of 25° C.) and/or may exhibit change in viscosity of less than 100% (e.g., less than 50%) on an absolute basis upon aging at 50° C. for 4 weeks (as measured by a Brookfield rheometer and at a temperature of 25° C., where the viscosity remains less than 1,000 cP after aging at 50° C. for 4 weeks), as calculated per Eq. 2 below:

$$\% Change = \frac{( Fresh - Aged )}{Fresh} \qquad Eq . 2$$

In another aspect, the present technology provides a method of making a coating composition of any of the embodiments disclosed herein. The method includes combining the colloidal silica functionalized with anionic molecules as described herein and/or the colloidal silica functionalized with neutral molecules as described herein with additional coating components to form the coating composition.

The method of making the coating composition of any embodiment herein may include forming a grind phase by mixing the colloidal silica functionalized with anionic molecules as described herein and/or the colloidal silica functionalized with neutral molecules as described herein with additional coating component. Mixing may be via any suitable mixer or disperser. The grind phase may be mixed with a letdown phase to form the coating composition.

Forming the grind phase may include mixing the colloidal silica functionalized with anionic molecules as described herein and/or the colloidal silica functionalized with neutral molecules as described herein with water, and other components, as described herein, in weight ratios as described herein. In any embodiment, the grind phase may further be formed by mixing the water and functionalized colloidal silica with a neutralizer, a matting agent, a biocide a pigment, a pigment dispersant, a defoamer, a wetting agent, a nonionic surfactant, or a combination thereof, as described herein, to form the grind phase. In any embodiment, the grind phase may further be formed by mixing the water and functionalized colloidal silica with a neutralizer, a matting agent, a biocide, a pigment, a pigment dispersant, a defoamer, a wetting agent, and a nonionic surfactant, as described herein.

The coating composition may be formed by mixing the grind phase with a letdown phase. The letdown phase may include a binder, a neutralizer, a coalescent, a rheology modifier, as described herein, or a combination of two or more thereof. In any embodiment, the coating composition may be formed by mixing the grind phase with a binder, a neutralizer, a coalescent, and a rheology modifier.

In any embodiment, forming the grind phase may include mixing the functionalized colloidal silica with water, and, optionally, a neutralizer, a matting agent, a biocide, a pigment, a pigment dispersant, a defoamer, a wetting agent, a nonionic surfactant, or a combination thereof, as described herein; and forming the coating composition includes mixing the grind phase with the binder, and, optionally, a neutralizer, a coalescent, a rheology modifier, or a combination of two or more thereof.

The method of making the coating composition of any embodiment herein may include mixing the functionalized colloidal silica with a binder, a coalescent, a surfactant, a rheology modifier, or a combination of two or more thereof to form the coating composition. In any embodiment herein, making the coating composition may include mixing the functionalized colloidal silica with a binder, a coalescent, a surfactant, and a rheology modifier, as described herein.

The present technology, thus generally described, will be understood more readily by reference to the following examples, which are provided by way of illustration and are not intended to be limiting of the present technology.

### EXAMPLES

### Example 1. Preparation of Functionalized Colloidal Silica

Commercially available LUDOX colloidal silica grades were used in these examples. These products were supplied by W. R. Grace &Co. Similar products, such as Levasil, available from Nouryon, AMSol, available from Applied Material Solutions, Köstrosol1540 from CWK Chemiewerk Bad Köstritz GmbH, Nalco 1140 from Nalco Water, Snowtex from Nissan Chemical, etc. can also be used.

All the chemicals used in these examples came from common suppliers such as SigmaAldrich, Fisher Scientific, TCJ America and Gelest, Inc., unless otherwise specified. These chemicals were purchased and used without further purifications.

To calculate the silane treatment levels for colloidal silica particles, 345 m²/g surface area was used for 7 nm grade of colloidal silica (e.g. LUDOX SM), 220 m²/g surface area for 12 nm grade of colloidal silica (e.g. LUDOX HS-40 or LUDOX AM or LUDOX CL), 140 m²/g surface area for 22 nm grade of colloidal silica (e.g. LUDOX™-40), and 75 m²/g surface area for 40 nm grade (e.g. LUDOX PW-50 (X), a colloidal silica grade with polydispersed, different sized silica particles). The treatment level (TL) is defined as number of molecules (NM) per square nanometer of solid particle surface area, or NM/nm².

Procedures for purifying functionalized colloidal silica included using Spectrum MidiKros hollow fiber membranes (e.g. D02-E050-10-S mPES/50 kD molecular weight cut-off (MWCO) with surface area of 75 cm²) (other types of membranes with suitable molecular weight cutoff can also be used). The colloidal silica samples were passed through the membranes via Tygon tubing with a peristaltic pump under a pressure of less than 25 psi. The permeates, containing impurities such as salts, and unbonded, free organic molecules, were collected and the total volume was measured. The typical solids for the colloidal silica were between 5-25%, and fresh deionized (DI) water was added to make up the volume lost in the permeates. Typically, 5-10 volumes of permeates were accumulated against the initial total volume of the colloidal samples before the completion of the ultrafiltration process.

The general method for elemental analysis of functionalized particles for carbon (C %), hydrogen (H %), nitrogen (N %), and sulfur (S %) included placing small amounts of the purified colloidal samples in a glass vials. The vials were dried in an oven at 90° C. overnight. The dried solids were collected, and they were subjected to elemental analysis with LECO G4 ICARUS Series 2 analyzer or PerkinElmer 2400 series.

Titration methods were used. For zeta titrations, a Colloid Dynamics AcoustoSizer IIX coupled to an auto-titrator unit was used to measure zeta potentials as functions of pH by an electroacoustic method. For typical runs, colloidal solutions were prepared with 5% colloidal solids by dilution of the original sample with DI water. Potentiometric titrations were performed starting at the colloidal solutions nascent pH and run either up to pH 9 (for colloidal solutions with nascent pH less than 7) or down to pH 3 (for colloidal solutions with nascent pH greater than 7) and then back to either pH 9 or 3, respectively. The pre-loaded instrument parameters for SiO₂ (silica, amorphous-typical) and water were used by the software. Titrations were done with 0.1 N HCl and 0.1 N NaOH.

For dynamic light scattering (DLS) particle size measurement, a Malvern Zetasizer Nano-S90 model number ZEN1690 was utilized. Solutions of 2% wt. colloidal solids were prepared by dilution of the original colloidal solutions with DI water. Once diluted, the colloidal solutions were filtered with a 0.45-micron syringe filter into the measurement cuvette. Measurements were accumulated for 60 seconds. The values reported are D50 on a volume basis.

### Example 1A. Sodium Mercaptoethanesulfonate on LUDOX HS-40

Sodium 2-mercaptoethanesulfonate (98% purity, available from Aldrich), 3.61 g, was dissolved in 30 mL of DI water. The pH of the solution was around 5.3. To the stirred solution was added dropwise 5.20 g of (3-glycidyloxypropyl)trimethoxysilane (glycidylsilane) (treatment level of 2.0 molecules/nm² of particle surface). The mixture was stirred at room temperature for about 1 hour. In a 250 mL beaker, 75 g of LUDOX HS-40 (about 30 g of dried SiO₂) was weighed, and then diluted with 30 mL of DI water. While mixing, the silane solution was slowly added into the colloidal silica dropwise, at room temperature. Once added, the solution was allowed to mix at room temperature for 1 hour. After 1 hour, the sample was heated at 60-70° C. and the solution was allowed to mix for another 1 hour at this temperature. After the reaction, the mixture was allowed to cool down to room temperature and the sample was diafiltered with 6 volumes of DI water. A small sample was taken and dried at 90° C. overnight and elemental analysis was carried out to determine the carbon content of the dried sample.

The following Reaction Scheme I shows the reaction scheme of this example.

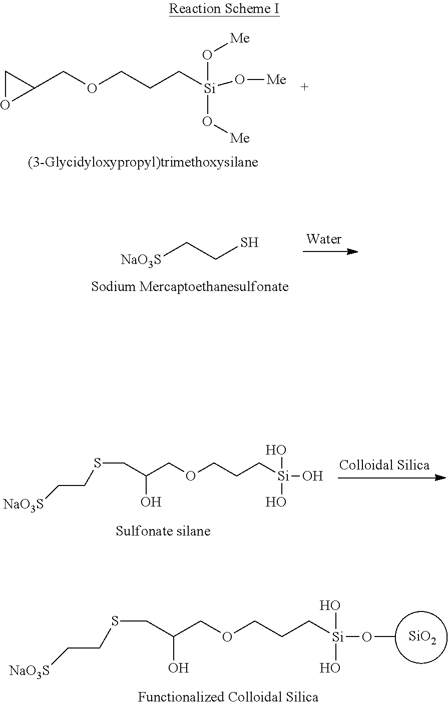

### Example 1B. Sodium Mercaptopropanesulfonate on LUDOX HS-40

Sodium 3-mercapto-1-propanesulfonate (>85% purity, available from TCI America), 4.61 g, was dissolved in 30 mL of DI water. The pH of the solution was about 1.7. To the stirred solution was added dropwise 5.20 g of (3-glycidyloxypropyl)trimethoxysilane (glycidylsilane) (treatment level of 1.7 molecules/nm² of particle surface). The mixture was stirred at room temperature for about 1 hour. In a 250 mL beaker, 75 g of LUDOX HS-40 (about 30 g of dried SiO₂) was weighed and diluted with 30 mL of DI water. While mixing, the silane solution was slowly added into the colloidal silica dropwise, at room temperature. Once added, the solution was allowed to mix at room temperature for 1 hour. After 1 hour, the sample was heated at 60-70° C. and allowed to mix for another 1 hour at this temperature. After the reaction, the mixture was allowed to cool down to room temperature and the sample was diafiltered with 6 volumes of DI water. A small sample was taken and dried at 90° C. overnight and elemental analysis was carried out to determine the carbon content of the dried sample. The C % and S % contents of the dried samples were 3.79% and 0.31%, respectively.

The following Reaction Scheme II shows the reaction scheme of this example.

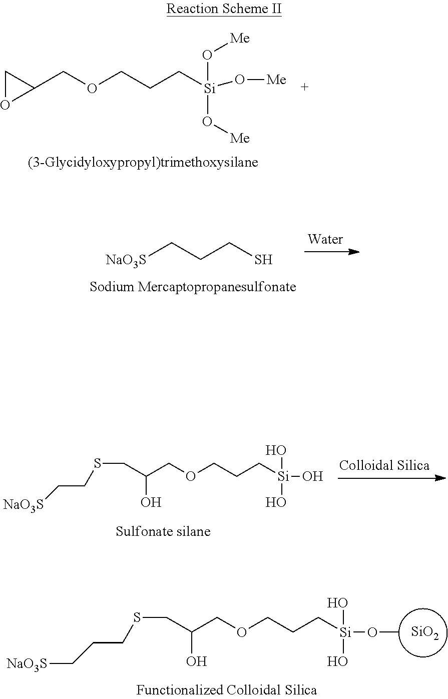

### Example 1C. Sulfanilic Acid Modification on LUDOX HS-40

11.4 g of sulfanilic acid was dissolved in 60 mL of DI water and the pH of the solution was adjusted to about 6.0 with 5 M NaOH. To the stirred solution was added 10.4 g of glycidylsilane (treatment level of 2.0 molecules/nm² of particle surface). The mixture was stirred at room temperature for 1 hour, and then heated at 60° C. for 2 hours. In a 300 mL beaker, 150 g of LUDOX HS-40 (about 60 g of dried SiO₂) were mixed with 50 mL of DI water, and to the stirred colloidal mixture was added the silane solution slowly and over 10 minutes. The resulting mixture was stirred for 1 hour at room temperature, and for 2 hours at 70° C. The sample was diafiltered with 6 volumes of DI water. Elemental analysis of a small, dried sample showed C %=4.28%, N %=0.40%, and S %=0.63%.

The following Reaction Scheme III shows the reaction scheme of this example.

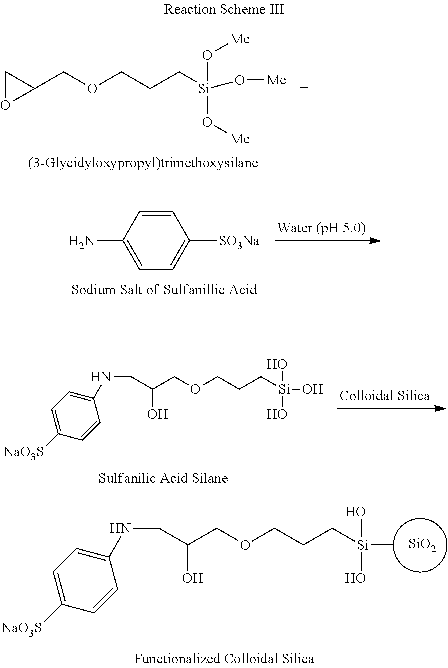

### Example 1D. Isophthalic Acid Modification on LUDOX HS-40

2.99 g of 5-aminoisophthalic acid was formed into a slurry in 80 mL of DI water. The pH of the solution was adjusted to about 6.0 with 1 M NaOH. To the stirred solution was added 3.90 g of glycidylsilane (treatment level of 1.5 molecules/nm² of particle surface). The mixture was stirred overnight (about 15 hours) at room temperature, and the pH was kept at about 6.0 with addition of 1 M NaOH. Then the mixture was heated at 50° C. until all solids were dissolved. In a 300 mL beaker, 75 g of LUDOX HS-40 (about 30 g of dried SiO₂) were mixed with 30 mL of DI water, and to the stirred colloidal mixture was added the silane solution slowly and over 10 minutes. The resulting mixture was stirred for 1 hour at room temperature, and for 2 hours at 70° C. The sample was diafiltered with 5 volumes of DI water. Elemental analysis of a small, dried sample showed C %=3.45%, and N %=0.22%.

The following Reaction Scheme IV shows the reaction scheme in this example.

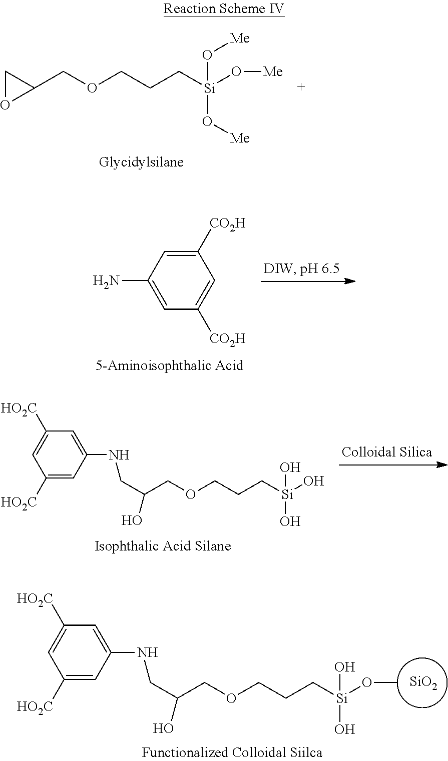

### Example 1E. Taurine Modification on LUDOX HS-40

81.0 g of glycidylsilane (treatment level of 1.7 molecules/nm² of particle surface) was mixed with 135 g of DI water until the silane completely dissolved (in about 2 hours). In a separate beaker, taurine, 65.0 g, was dissolved in 250 ml of DI water. The pH of the solution was adjusted to 9.5 with 1 M NaOH. In a 3 L beaker, 1375 g of LUDOX HS-40 (about 550 g of dried SiO₂) were mixed with 825 ml of DI water, and to the stirred colloidal silica was added first the taurine solution, followed by the silane solution slowly. The mixture was gradually heated to 70° C. and kept heated at 70° C. for 2 hours. The sample was diafiltered with 5 volumes of DI water. Elemental analysis of a small, dried sample showed C %=3.43%, and S %=0.36%.

The following Reaction Scheme V shows the reaction scheme of this example.

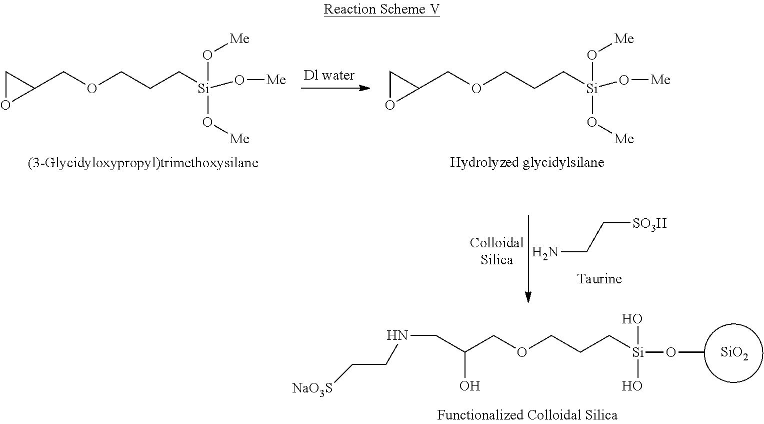

### Example 1F. Succinic Modification on LUDOX HS-40

In a stirred 100 ml beaker, 6.70 g (22.5 mmol, treatment level of 2.0 molecules/nm² of particle surface) of (3-triethoxysilyl)propyl succinic anhydride and 30 ml of DI water were mixed. The pH of the stirred mixture was kept around 6.0 with addition of 5 M NaOH solution. After 40 minutes, a clear solution was formed and the pH was stabilized. After that, the aqueous solution was added dropwise to 66.7 g of 30% colloidal silica (diluted LUDOX® HS-40). The mixture was stirred at room temperature for 1 hour, and then heated to 70° C. for another hour and then the mixture was allowed to cool down to room temperature. The resulting mixture was purified by ultrafiltration with 5 volumes of DI water. The C % of the dried, purified particles were 2.57%.

### Example 1G. Diol Modification on LUDOX HS-40

2.95 g of the glycidylsilane (treatment level of 1.7 molecules/nm² of particle surface) were mixed with 5 ml of DI water for 2 hours. A clear solution was formed after 2 hours. 50 g of LUDOX® HS-40 were diluted to 20% solids with 50 g of DI water. The stirred colloidal silica was heated to 60° C. with a water bath. To the colloidal silica was slowly added the aqueous silane solution over 1 hour. After the addition, the heating was continued for another 1 hour. After purification with 5 volumes of DI water, the corresponding functionalized colloidal silica was obtained. The C % content of a small, dried sample was determined to be 3.78%. The resulting functionalization may be represented as follows:

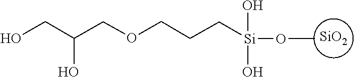

### Example 1H. Sorbitol Modification on LUDOX HS-40

In a 50 mL beaker with a stir bar, slowly added the 4.08 g of 2 M methanesulfonic acid (MSA) and 1.22 g of deionized water. The beaker was heat to around 55-60° C. with a water bath. Then, while stirring, 10.19 g of D-sorbitol were added in small portions. Once the solids are dissolved and the solution was clear, stopped the heating of the water bath. Slowly added 6.12 g of (3-glycidyloxypropyl)trimethoxysilane (treatment level of 1.5 molecules/nm² of particle surface) dropwise with vigorous mixing (the reaction is strongly exothermic). Allowed the solution to turn clear and kept mixing for another 30 minutes at 60° C. A viscous clear liquid was formed. In a 250 mL beaker, 100 g of LUDOX HS-40 (about 30 g of dried SiO₂) was weighed. While mixing, the silane solution was slowly added into the colloidal silica dropwise, at room temperature (20° C. to 30° C.). Once added, the solution was allowed to mix at room temperature for 1 hour. After 1 hour, the sample was heated to 60-70° C. and the solution was allowed to mix for another hour at high temperature. After the reaction, the mixture was allowed to cool down to room temperature and the sample was diafiltered with 6 volumes of deionized water. A small sample was taken and dried at 90° C. overnight and elemental analysis was carried out to determine the carbon content of the dried sample.

Reaction Scheme VII illustrates the chemical transformation from the example. As shown, during the reaction of glycidylsilane and sorbitol in water with catalytic amount of MSA acid, since both water molecule and glycerol molecule would compete and react with epoxy ring of the glycidylsilane, it was expected that the formation of sorbitol silane (from the reaction with sorbitol) and diol silane (from the reaction with water) could happen, and the ratio of the two new silanes might depend on the amount of the water in the system, and the reaction conditions.

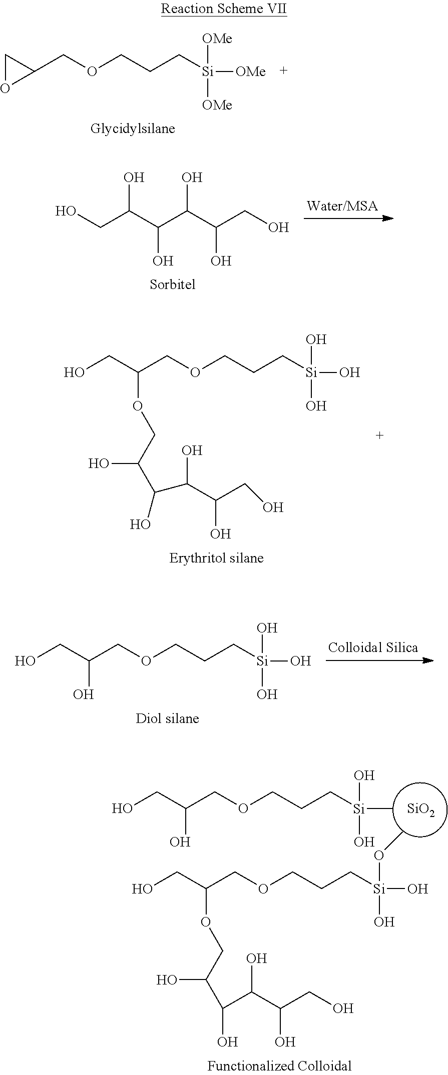

### Example 1I. TRIS Base Modification on LUDOX HS-40

In a 50 ml beaker, 2.95 g (12.5 mmol) of glycidylsilane (treatment level of 1.7 molecules/nm² of particle surface), 1.51 g (12.5 mmol) of TRIS base (i.e., tris(hydroxymethyl)aminomethane) and 20 mL of methanol were mixed with a stir bar. The mixture was heated to 55° C. in a water bath until a clear solution was formed. The structure of the newly formed silane is as follows:

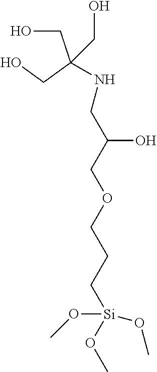 [SMILES: CO[Si](CCCOCC(O)CNC(CO)(CO)CO)(OC)OC]

After that, the methanol solution of the new silane was added dropwise to 66.7 g of 30% colloidal silica (diluted HS-40). The mixture was stirred at room temperature for 1 hour, and then heated to 70° C. for another hour and then the mixture was allowed to cool down to room temperature. The resulting mixture was purified by ultrafiltration with 5 volumes of deionized (DI) water. The resulting functionalization may be represented as follows:

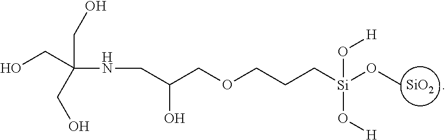

### Example 1J. Glycerol Modification on LUDOX HS-40

The synthesis of glycerol-modified LUDOX HS-40 was performed in a similar fashion as described for the sorbitol modification of Example 1I, using glycerol instead of sorbitol. Reaction Scheme VIII illustrates the chemical transformation from of this example.

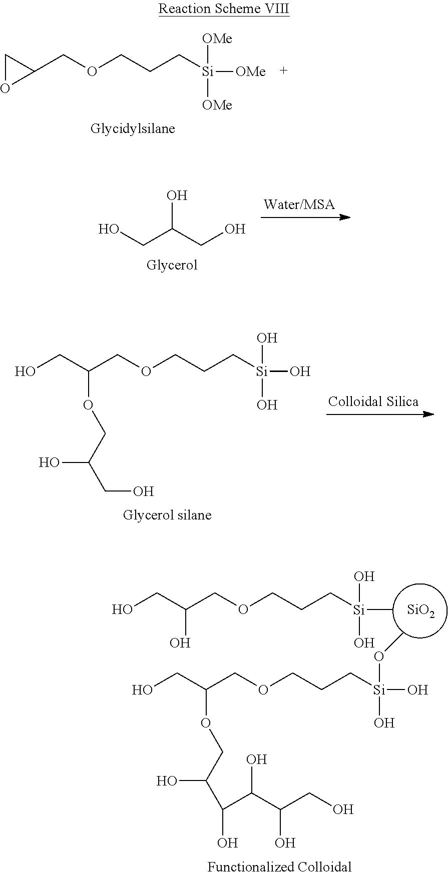

### Example 2: Preparation of Exemplary Coating Compositions for Dirt Pickup Resistance (DPUR) Testing

Matte and glossy coatings were prepared to test DPUR. Table 1 shows colloidal silica functionalization tested in the exemplary matte coatings of Table 3, which included three example matte coatings of the present technology (Examples 2A-2C) and four comparative matte coatings (Comparative Examples 2α-2δ). Table 2 shows colloidal silica functionalization tested in exemplary glossy coatings of Table 4, which included three example glossy coatings of the present technology (Examples 2D-2F) and comparative glossy coatings (Comparative Examples 2ε-2θ). The “% solids” of the amount of colloidal silica was determined by drying a weighed portion of the sample at 90° C. for 4 hours, where the solid residue left after drying is weighted again and the % solids is calculated as [(weight of residue)/(weight of sample)]X 100%.

TABLE 1
Matte Coating Functionalization

| | Colloidal Silica | Colloidal Silica |
|---|---|---|
| Coating | (Functionalization) | Amount (% solids) |
| Comparative Example 2α | No colloidal silica | n/a |
| (“Comp. Ex. 2α”) | | |
| Comp. Ex. 2β | LUDOX HS-40 (no | 40.0 |
| | functionalization) | |
| Comp. Ex. 2γ | Example 1G (Diol; Neutral | 33.2 |
| | Functionalization) | |
| Comp. Ex. 2δ | Example 1I (TRIS; Cationic | 31.8 |
| | Functionalization) | |
| Example 1 (“Ex. 2A”) | Example 1F (Succinic acid; | 35.2 |
| | anionic functionalization) | |
| Ex. 2B | Example 1B (SMPS; anionic | 29.7 |
| | functionalization) | |
| Ex. 2C | Example 1C (Sulfanillic; | 31.0 |
| | anionic functionalization) | |

TABLE 2
Glossy Coating Functionalization

| | Colloidal Silica | Colloidal Silica |
|---|---|---|
| Coating | Functionalization | Amount (% solids) |
| Comp. Ex. 2ε | No colloidal silica | n/a |
| Comp. Ex. 2ζ | LUDOX HS-40 (no | 40.0 |
| | functionalization) | |
| Comp. Ex. 2η | Example 1G (Diol; Neutral | 33.2 |
| | Functionalization) | |
| Comp. Ex. 2θ | Example 1I (TRIS; Cationic | 31.8 |
| | Functionalization) | |
| Ex. 2D | Example IF (Succinic acid; | 35.2 |
| | anionic functionalization) | |
| Ex. 2E | Example 1B (SMPS; anionic | 29.7 |
| | functionalization) | |
| Ex. 2F | Example 1C (Sulfanillic; | 31.0 |
| | anionic functionalization) | |

The matte and glossy coatings were prepared with the components and weight percentages provided in Tables 3 and 4, respectively. In addition to the functionalized colloidal silica synthesized as disclosed herein, coating compositions included one or more of the following chemicals: 2-amino-2-methyl-1-propanol (AMP-95™ by ANGUS Chemical Company), unfunctionalized colloidal silica (LUDOX® HS-40 by W. R. Grace & Co.), isothiazolinone preservative (KATHON™ LX by Dow), hydrophilic copolymer dispersant (TAMOL™ 1124) by Dow, acrylic polymer binder (RHOPLEX™ VSR-50) by Dow, silicone-based surface agent (BYK 348) by BYK, polyether siloxane defoamer (TEGO™ Foamex 810 by Evonik), secondary alcohol ethoxylate nonionic surfactant TRITON™ CF-10 by Dow, rutile titanium dioxide pigment Ti-Pure™ R-706 by Chemours, micronized functional filler and/or extender produced from nepheline syenite (MINEX®-4 by Unimin), 2,2,4-Trimethyl-1,3-pentanediol monoisobutyrate (TEXANOL™ by Eastman), Natrosol™ 330 by Ashland used as a 3% solution in water, hydrophobically modified ethylene oxide urethane rheology modifier ACRYSOL™ RM-3000 by Dow, and hydrophobically modified ethylene oxide urethane rheology modifier ACRYSOL™ RM-8W by Dow.

Coating compositions were prepared by forming a grind mix followed by a letdown step. The letdown step included incorporation of letdown components to the grind mix. The grind mix included water, AMP-95™, colloidal silica, KATHON™ LX, TAMOL™ 1124, BYK 348, TEGO™ Foamex 810, TRITON™ CF-10, Ti-Pure™ R-706, and MINEX™-4 mixed in the weight ratios according to Tables 3 and 4. The example coating compositions included colloidal silica functionalized with anionic molecules (succinic modified, sodium mercaptopropanesulfonate, SMPS) modified, or sulfanilic acid modified) as compared to non-functionalized colloidal silica or colloidal silica functionalized with a cationic group (TRIS modified) or a neutral group (diol modified). The grind mix were combined and sheared using a high speed Cowles disperser.

Separately, some of the letdown components were prepared. In a separate vessel RHOPLEX™ VSR-50, TEXANOL™, propylene glycol, and AMP-95™ were combined to form a mixture in the weight ratios according to Tables 3 and 4. The grind mix was then added to the mixture, followed by Natrosol™ 330, ACRYSOL™ RM-3000, and ACRYSOL™ RM-8W to form the coating compositions.

TABLE 3
Matte Coating Compositions

| | | Comp. | Comp. | Comp. | Comp. | | | |
|---|---|---|---|---|---|---|---|---|
| | | Ex. 2α | Ex. 2β | Ex. 2γ | Ex. 2δ | Ex. 2A | Ex. 2B | Ex. 2C |
| Component | Function | Wt. % | Wt. % | wt. % | wt. % | wt. % | wt. % | wt. % |
| GRIND | | | | | | | | |
| Water | Diluent | 21.5 | 11.5 | 9.5 | 8.9 | 10.1 | 8.0 | 8.6 |
| AMP-95 ™ | Neutralizer | 0.02 | 0.02 | 0.02 | 0.02 | 0.02 | 0.02 | 0.02 |
| Colloidal Silica | Additive | 0.0 | 10.0 | 12.0 | 12.6 | 11.4 | 13.5 | 12.9 |
| KATHON ™ | In-Can Biocide | 0.15 | 0.15 | 0.15 | 0.15 | 0.15 | 0.15 | 0.15 |
| LX | | | | | | | | |
| TAMOL ™ | Pigment | 0.60 | 0.60 | 0.60 | 0.60 | 0.60 | 0.60 | 0.60 |
| 1124 | Dispersant | | | | | | | |
| BYK 348 | Wetting Agent | 0.18 | 0.18 | 0.18 | 0.18 | 0.18 | 0.18 | 0.18 |
| TEGO ™ | Defoamer | 0.14 | 0.14 | 0.14 | 0.14 | 0.14 | 0.14 | 0.14 |
| Foamex 810 | | | | | | | | |
| TRITON ™ CF- | Surfactant | 0.19 | 0.19 | 0.19 | 0.19 | 0.19 | 0.19 | 0.19 |
| 10 | | | | | | | | |
| Ti-Pure ™ R- | Pigment | 16.1 | 16.1 | 16.1 | 16.1 | 16.1 | 16.1 | 16.1 |
| 706 | | | | | | | | |
| MINEX ®-4 | Matting Agent | 21.7 | 21.7 | 21.7 | 21.7 | 21.7 | 21.7 | 21.7 |
| LETDOWN | | | | | | | | |
| RHOPLEX ™ | Binder | 30.7 | 30.7 | 30.7 | 30.7 | 30.7 | 30.7 | 30.7 |
| VSR-50 | | | | | | | | |
| Texanol ™ | Coalescent | 0.42 | 0.42 | 0.42 | 0.42 | 0.42 | 0.42 | 0.42 |
| Propylene | Open time | 0.60 | 0.60 | 0.60 | 0.60 | 0.60 | 0.60 | 0.60 |
| Glycol | | | | | | | | |
| Water | Diluent | 1.2 | 1.2 | 1.2 | 1.2 | 1.2 | 1.2 | 1.2 |
| AMP-95 ™ | Neutralizer | 0.10 | 0.10 | 0.10 | 0.10 | 0.10 | 0.10 | 0.10 |
| Natrosol ™ 330 | Rheology - | 3.4 | 3.4 | 3.4 | 3.4 | 3.4 | 3.4 | 3.4 |
| (3%) | Low Shear | | | | | | | |
| ACRYSOL ™ | Rheology - | 2.3 | 2.3 | 2.3 | 2.3 | 2.3 | 2.3 | 2.3 |
| RM-3000 | High Shear | | | | | | | |
| ACRYSOL ™ | Rheology - | 0.79 | 0.79 | 0.79 | 0.79 | 0.79 | 0.79 | 0.79 |
| RM-8W | Mid Shear | | | | | | | |
| Propylene | Open time | 0.60 | 0.60 | 0.60 | 0.60 | 0.60 | 0.60 | 0.60 |
| Glycol | | | | | | | | |
| Water | Diluent | 1.2 | 1.2 | 1.2 | 1.2 | 1.2 | 1.2 | 1.2 |
| AMP_95 ™ | Neutralizer | 0.10 | 0.10 | 0.10 | 0.10 | 0.10 | 0.10 | 0.10 |
| Natrosol ™ 330 | Rheology - | 3.4 | 3.4 | 3.4 | 3.4 | 3.4 | 3.4 | 3.4 |
| (3%) | Low Shear | | | | | | | |
| ACRYSOL ™ | Rheology - | 2.3 | 2.3 | 23 | 2.3 | 2.3 | 2.3 | 2.3 |
| RM-3000 | High Shear | | | | | | | |
| ACRYSOL ™ | Rheology - | 0.79 | 0.79 | 0.79 | 0.79 | 0.79 | 0.79 | 0.79 |
| RM-8W | Mid Shear | | | | | | | |

TABLE 4
Glossy Coating Compositions

| | | Comp. | Comp. | Comp. | Comp. | | | |
|---|---|---|---|---|---|---|---|---|
| | | Ex. 2ε | Ex. 2ζ | Ex. 2η | Ex. 2θ | Ex. 2D | Ex. 2E | Ex. 2F |
| Component | Function | wt. % | wt. % | wt. % | wt. % | wt.5% | wt. % | wt. % |
| GRIND | | | | | | | | |
| Water | Diluent | 17.2 | 7.2 | 5.2 | 4.6 | 5.9 | 3.8 | 4.3 |
| AMP-95 ™ | Neutralizer | 0.02 | 0.02 | 0.02 | 0.02 | 0.02 | 0.02 | 0.02 |
| Colloidal | Additive | 0.0 | 10.0 | 12.0 | 12.6 | 11.3 | 13.4 | 12.8 |
| Silica | | | | | | | | |
| KATHON ™ | In-Can | 0.17 | 0.17 | 0.17 | 0.17 | 0.17 | 0.17 | 0.17 |
| LX | Biocide | | | | | | | |
| TAMOL ™ | Pigment | 0.68 | 0.68 | 0.68 | 0.68 | 0.68 | 0.68 | 0.68 |
| 1124 | Dispersant | | | | | | | |
| BYK 348 | Wetting | 0.21 | 0.21 | 0.21 | 0.21 | 0.21 | 0.21 | 0.21 |
| | Agent | | | | | | | |
| TEGO ™ | Defoamer | 0.16 | 0.16 | 0.16 | 0.16 | 0.16 | 0.16 | 0.16 |
| Foamex 810 | | | | | | | | |
| TRITON ™ | Surfactant | 0.22 | 0.22 | 0.22 | 0.22 | 0.22 | 0.22 | 0.22 |
| CF-10 | | | | | | | | |
| Ti-Pure ™ R- | Pigment | 19.3 | 19.3 | 19.3 | 19.3 | 19.3 | 19.3 | 19.3 |
| 706 | | | | | | | | |
| MINEX ®-4 | Matting | 0 | 0 | 0 | 0 | 0 | 0 | 0 |
| | Agent | | | | | | | |
| LETDOWN | | | | | | | | |
| RHOPLEX ™ | Binder | 55.3 | 55.3 | 55.3 | 55.3 | 55.3 | 55.3 | 55.3 |
| VSR-50 | | | | | | | | |
| Texanol ™ | Coalescent | 0.75 | 0.75 | 0.75 | 0.75 | 0.75 | 0.75 | 0.75 |
| Propylene | Open time | 0.68 | 0.68 | 0.68 | 0.68 | 0.68 | 0.68 | 0.68 |
| Glycol | | | | | | | | |
| Water | Diluent | 1.0 | 1.0 | 1.0 | 1.0 | 1.0 | 1.0 | 1.0 |
| AMP-95 ™ | Neutralizer | 0.10 | 0.10 | 0.10 | 0.10 | 0.10 | 0.10 | 0.10 |
| Natrosol ™ | Rheology - | 2.0 | 2.0 | 2.0 | 2.0 | 2.0 | 2.0 | 2.0 |
| 330 (3%) | Low Shear | | | | | | | |
| ACRYSOL ™ | Rheology - | 1.8 | 1.8 | 1.8 | 1.8 | 1.8 | 1.8 | 1.8 |
| RM-3000 | High Shear | | | | | | | |
| ACRYSOL ™ | Rheology - | 0.49 | 0.49 | 0.49 | 0.49 | 0.49 | 0.49 | 0.49 |
| RM-8W | Mid Shear | | | | | | | |

### Example 3: Characterization of Example 2 Coating Compositions

The viscosities of the coating compositions of Example 2 were determined. The ICI viscosity was measured using a CAP 2000+ viscometer made by BYK and equipped with Number 1 spindle at 900 rpm and at 25° C. The KU viscosity was measured using a KU-2 viscometer made by BYK.

“Fresh” coating composition viscosity measurements were performed after allowing the coating compositions to rest for 24 hours at room temperature. The rheological stability of the coating compositions was evaluated by aging the coating compositions at 52° C. for 2 weeks and 4 weeks. Viscosity measurements were performed after equilibration of the paint to room temperature (i.e., 20° C.-25° C.). Results are shown in Table 5.

TABLE 5
Viscosity Measurements of Coating Compositions

| Coating | Fresh | | 2 weeks at 52° C. | | 4 weeks at 52° C. | |
|---|---|---|---|---|---|---|
| Composition | ICI | KU | ICI | KU | ICI | KU |
| Comp. Ex. 2α | 0.96 | 102 | 0.95 | 101 | 0.84 | 97 |
| Comp. Ex. 2β | Unstable | Unstable | Unstable | Unstable | Unstable | Unstable |
| Comp. Ex. 2γ | 0.94 | 102 | 0.81 | 100 | 0.86 | 100 |
| Comp. Ex. 2δ | 0.90 | 102 | 0.83 | 100 | 0.81 | 101 |
| Ex. 2A | 0.99 | 100 | 0.78 | 103 | 0.77 | 102 |
| Ex. 2B | 0.98 | 106 | 0.86 | 105 | 0.83 | 105 |
| Ex. 2C | 1.14 | 102 | 0.94 | 102 | 0.92 | 102 |
| Comp. Ex. 2ε | 1.02 | 106 | 1.04 | 109 | 1.03 | 107 |
| Comp. Ex. 2ζ | Unstable | Unstable | Unstable | Unstable | Unstable | Unstable |
| Comp. Ex. 2η | 0.96 | 106 | 0.99 | 109 | 1.01 | 112 |
| Comp. Ex. 2θ | 0.71 | 107 | 0.73 | 108 | 0.74 | 108 |
| Ex. 2D | 1.14 | 104 | 0.91 | 114 | 0.94 | 117 |
| Ex. 2E | 0.95 | 108 | 0.89 | 110 | 0.92 | 113 |
| Ex. 2F | 0.86 | 105 | 0.86 | 107 | 0.88 | 110 |

The gloss values of the coating compositions were also characterized. The gloss values at angles of 60′ and 85′ were measured using a micro-TRI-gloss instrument manufactured by BYK Gardner. Formulations were applied using a 4 mil wet film thickness Bird film applicator on a Plain Black Charts (BK B #5306) manufactured by LENETA. The coatings were allowed to dry for at least three days before performing the gloss measurements. Gloss value results are shown in Table 6.

TABLE 6
Gloss Values of Coating Compositions

| Coating | | |
|---|---|---|
| Composition | Gloss Units @ 60° | Gloss Units @ 85° |
| Comp. Ex. 2α | 2 | 2 |
| Comp. Ex. 2β | Unstable | Unstable |
| Comp. Ex. 2γ | 3 | 6 |
| Comp. Ex. 2δ | 3 | 5 |
| Ex. 2A | 4 | 7 |
| Ex. 2B | 4 | 8 |
| Ex. 2C | 4 | 6 |
| Comp. Ex. 2ε | 73 | 93 |
| Comp. Ex. 2ζ | Unstable | Unstable |
| Comp. Ex. 2η | 75 | 95 |
| Comp. Ex. 2θ | 71 | 95 |
| Ex. 2D | 74 | 97 |
| Ex. 2E | 75 | 96 |
| Ex. 2F | 76 | 90 |

Comparative Examples 2α and 2ε did not contain any colloidal silica and produced stable formulations.

Comparative Example 2β and Comparative Example 2ζ as prepared did not result in a stable composition. Both of these compositions included unfunctionalized colloidal silica, and thus relied on electrostatic repulsion for stabilization, but not steric forces. Steric forces are present in functionalized colloidal silica compositions to promote stabilization. This indicates that the functionalization of the colloidal silica may promote product stability. Furthermore, there may be an incompatibility between the unfunctionalized colloidal silica and other components in the grind phase that prevent the formation of a stable composition. The incompatibility between components may prevent the wide use of unfunctionalized colloidal silica in typical paint formulations.

Functionalization of the colloidal silica may improve its compatibility with other components in the grind phase. For example, diol functionalized colloidal silicas, prepared in accordance with Example 1H, was formulated into stable formulations as shown in Comparative Examples 2γ and 2η. The diol functionality is considered neutral, since the hydroxyl groups are not ionized in the coating formulation having a pH of about 7 to about 9.5.

TRIS functionalized colloidal silica, prepared in accordance with Example 1J, was similarly formulated into stable formulations, as shown in Comparative Examples 2δ and 2θ. The amine group is considered a cationic group in the coating formulation having a pH of about 7 to about 9.5.

Coatings including silica functionalized with anionic groups all provided stable formulations, as shown from the results with Examples 2A-2F.

### Example 4: Dirt Pickup Resistance (DPUR) Testing

A dirt simulant was made by dispersing carbon black (Darco Activated Carbon G-60) at 0.34 wt. % in water in the presence of a nonionic surfactant TRITON™ CF-10 at a concentration of 0.10 wt. %. A few drops of this dispersion were applied on the coating surface and allowed to dry at room temperature (e.g., 18° C. to about 25° C.) for five hours. Then the coatings were exposed to 60° C. and 100% relative humidity for 48 hours to simulate accelerated aging. The hot and humid conditions of accelerated aging may cause the coating to soften and trap carbon particles. After the accelerated aging, the coatings were allowed to dry at room temperature for 5 hours and gently rinsed with tap water until all the loose carbon deposits were removed. The rinsed coatings were allowed to dry at room temperature and evaluated visually.

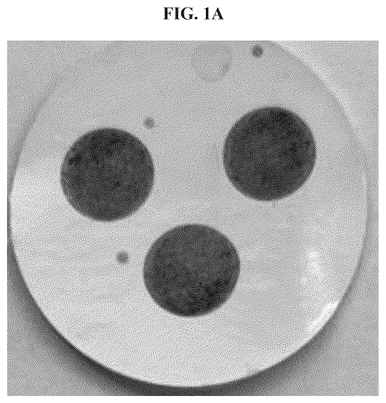

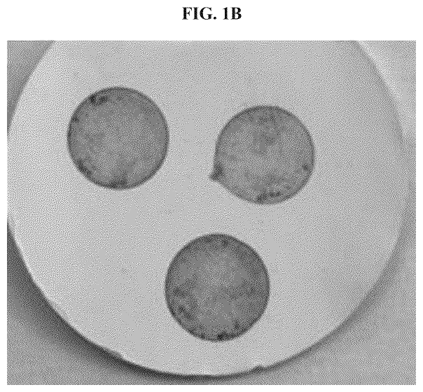

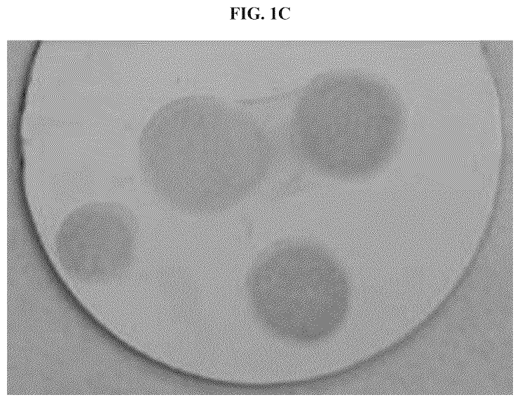

The DPUR rating was as follows. A rating of 1 means dark carbon spots remained and indicates poor DPUR. A rating of 2 means gray carbon spots remain, and indicates moderate DPUR. A rating of 3 means light gray carbon spots remained, and indicates good DPUR. FIG. 1A-1C provide illustrative photographs of examples of coatings with different dirt pickup ratings (DPURs). FIG. 1A is a photograph of a coating with a DPUR rating of 1. FIG. 1B is an illustrative photograph of a coating with a DPUR rating of 2. FIG. 1C is an illustrative photograph of a coating with a DPUR rating of 3. Results of the DPUR test are shown in Table 7.

TABLE 7
DPUR Ratings of Coating Compositions

| Coating Composition | DPUR Rating |
|---|---|
| Comp. Ex. 2α | 1 |
| Comp. Ex. 2β | N/A (Unstable) |
| Comp. Ex. 2γ | 1 |
| Comp. Ex. 2δ | 1 |
| Ex. 2A | 2 |
| Ex. 2B | 2 |
| Ex. 2C | 2 |
| Comp. Ex. 2ε | 1 |
| Comp. Ex. 2ζ | N/A (Unstable) |
| Comp. Ex. 2η | 1 |
| Comp. Ex. 2θ | 1 |
| Ex. 2D | 3 |
| Ex. 2E | 3 |
| Ex. 2F | 3 |

While the diol functionalized colloidal silica of Comparative Examples 2γ and 2η provided a stable formulation as shown in Example 3, the results show the diol functionalization did not provide any improvement in DPUR. Similarly, while the TRIS functionalized colloidal silica Comparative Examples 2δ and 2θ provided a stable formulation as shown in Example 3, the results show it did not provide any improvement in DPUR. The diol functionalization and TRIS functionalization are considered neutral and cationic, respectively, at the coating pH of about 7 to about 9.5.

In comparison, the coatings of Examples 2A-2F that included silica functionalized with anionic groups each provided stable formulations and improved the DPUR of the dry coating film.

### Example 5: Preparation of Coating Compositions for Corrosion Resistance Testing

Direct to metal (DTM) coatings were prepared. DTM coatings are used as a single coating in place of conventional two-coating systems including a primer and topcoat. DTM coatings may be applied directly to a metal surface. DTM coatings may be used to protect metal against corrosion, light abrasion, and weathering. Five example coatings (Examples 5A-5E) and six comparative example coatings (Comparative Examples 5α-5ζ) were prepared with different colloidal silica functionalization as noted in Table 8, where the components and amounts are listed in Table 9.

TABLE 8
DTM Coating Functionalization

| Coating | Colloidal Silica (Functionalization) |
|---|---|
| Comp. Ex. 5α | No colloidal silica |
| Comp. Ex. 5β | LUDOX HS-40 (no functionalization)^{a} |
| Comp. Ex. 5γ | LUDOX AS-40 (no functionalization)^{b} |
| Comp. Ex. 5δ | LUDOX HS-40 (no functionalization)^{a} |
| Comp. Ex. 5ε | LUDOX AS-40 (no functionalization)^{b} |
| Ex. 5A | Example 1J (Glycerol; Neutral Functionalization) |
| Ex. 5B | Example 1C (Sulfanillic; anionic functionalization) |
| Ex. 5C | Example 1B (SMPS; anionic functionalization) |

^{a}as described previously in this disclosure, LUDOX HS-40 is a 12 nm grade colloidal silica.
^{b}LUDOX AS-40 is a 22 nm grade colloidal silica with no functionalization.

The DTM coatings were prepared with the components and weight percentages provided in Table 9.

TABLE 9
Components in DTM Coatings (wt. %)

| | | Comp. | Comp. | Comp. | Comp. | Comp. | | | |
|---|---|---|---|---|---|---|---|---|---|
| Component | Function | Ex. 5α | Ex. 5β | Ex. 5γ | Ex. 5δ | Ex. 5ε | Ex. 5A | Ex. 5B | Ex. 5C |
| Acronal | Binder resin | 75.6 | 75.3 | 75.3 | 76.0 | 76.2 | 75.3 | 75.3 | 75.3 |
| PRO 770 | | | | | | | | | |
| Colloidal | Anticorrosive | 0.0 | 18.6 | 18.6 | 12.5 | 12.5 | 18.6 | 18.6 | 18.6 |
| Silica | | | | | | | | | |
| Water | Diluent | 19.2 | 0.9 | 0.9 | 6.3 | 6.3 | 0.9 | 0.9 | 0.9 |
| Ethylene | Coalescent | 4.3 | 4.3 | 4.3 | 4.4 | 4.4 | 4.3 | 4.3 | 4.3 |
| Glycol | | | | | | | | | |
| Monopropyl | | | | | | | | | |
| Ether | | | | | | | | | |
| Surfynol | Surfactant | 0.8 | 0.8 | 0.8 | 0.6 | 0.6 | 0.8 | 0.8 | 0.8 |
| 104E | | | | | | | | | |
| Rheovis PU | Rheology - | 0.1 | 0.1 | 0.1 | 0.1 | 0.1 | 0.1 | 0.1 | 0.1 |
| 1192 | Low Shear | | | | | | | | |

BASF Acronal 770 Pro NA = a styrene acrylic waterborne dispersion resin intended for direct-to-metal applications.
Surfynol 104E = a surfactant/defoamer available from Evonik.
Rheovis PU 1192 = a non-ionic polyurethane rheology modifier available from BASF.

Comparative Examples 5α and 5δ-5ε and Examples 5A-5B were characterized for their rheological stability. The rheological stability was measured by a Brookfield rheometer as freshly prepared (within 1-3 days of preparation), at 2 weeks at 25° C., and at 4 weeks at 25° C., providing values for the viscosity of the coatings. Viscosity results are shown in Table 10.

TABLE 10
Viscosity Testing (cP)

| Time | Comp. | Comp. | Comp. | | |
|---|---|---|---|---|---|
| Point | Ex. 5α | Ex. 5δ | Ex. 5ε | Ex. 5A | Ex. 5B |
| Fresh | 60 | 94 | 2200 | 120 | 638 |
| Week 1 | 105 | 569 | gelled | 225 | 770 |
| Week 2 | 145 | soft gel | — | 314 | 865 |
| Week 3 | 130 | — | — | 285 | 787 |
| Week 4 | 145 | — | — | 322 | 815 |

Table 10 shows that Comparative Examples 5δ and 5ε, made with commercial colloidal silica, gelled within 2 weeks or less after preparation. In the case of Comparative Example 5ε, the paint became unusable in about 3 days after preparation. In contrast, while the viscosity of Examples 5A and 5B incrementally increased a week after initial preparation, thereafter the viscosity of Examples 5A and 5B appeared to stabilize and still exhibited viscosity values useful in the successful generation films. The results indicate the functionalized colloidal silicas may provide stability to waterborne DTM Coatings with non-ionic Hydrophobically modified Ethoxylate Urethane-type (“HEUR-type”) rheology modifiers.

For elevated temperature stability at 50° C., another series of comparatives and examples was prepared as shown in Table 11:

TABLE 11
DTM Coating Functionalization:

| Coating | Colloidal Silica (Functionalization) |
|---|---|
| Comp. Ex. 5 ζ | No colloidal silica |
| Ex. 5D | Example 1J (Glycerol; Neutral Functionalization) |
| Ex. 5E | Example 1C (Sulfanillic; anionic functionalization) |

The DTM coatings used for elevated temperature storage stability were prepared with the components and weight percentages provided in Table 12.

TABLE 12
Components in DTM Coatings used for Elevated
Temperature Storage Stability Testing (wt. %)

| | | | Comp. | Ex. | Ex. |
|---|---|---|---|---|---|
| Step | Component | Function | Ex. 5ζ | 5D | 5E |
| Grind | Dispex Ultra PX 4290 | Dispersant | 0.8 | 0.8 | 0.8 |
| | Foamstar ST 2438 | Anti-foam | 0.5 | 0.5 | 0.5 |
| | Calcium Carbonate | Extender | 6.0 | 6.0 | 6.0 |
| | Water | Diluent | 25.0 | 25.0 | 25.0 |
| | TiPure R-900 | White pigment | 27.5 | 27.5 | 27.5 |
| Letdown | Acronal PRO 770 | Binder resin | 121.6 | 121.6 | 121.6 |
| | Colloidal Silica | Anticorrosive | 0.0 | 16.5 | 20.0 |
| | Water | Diluent | 20 | 3.5 | 0 |
| | Ethylene Glycol | Coalescent | 7.0 | 7.0 | 7.0 |
| | Monopropyl Ether | | | | |
| | Surfynol 104E | Surfactant | 1.3 | 1.3 | 1.3 |
| | Rheovis PU 1192 | Rheology - | 2.1 | 2.0 | 1.6 |
| | | Low Shear | | | |

BASF Dispex Ultra PX 4290 is a dispersing agent for aqueous coating systems.
BASF FoamStar ST 2438 is a hyperbranched polymer for foam reduction.
Chemours TiPure R-900 is a titanium dioxide white pigment

For this set of data, only paint formulas using organically modified colloidal silica were tested since the original comparatives with unmodified colloidal silica gelled even at room temperature. Results after storage at 50° C. shown in Table 13 below (viscosity measurements after each week for several weeks).

TABLE 13
Viscosity Testing (cP)

| Time | Comp. | Ex. | Ex. |
|---|---|---|---|
| Point | Ex. 5ζ | 5D | 5E |
| Fresh | 280 | 248 | 375 |
| Week 1 | 271 | 280 | 380 |
| Week 2 | 285 | 308 | 400 |
| Week 4 | 410 | 510 | 490 |

After 4 weeks, it can be seen that the coatings, which were formulated for a low-shear viscosity <1000 cP remain less than 1000 cP for the entire test period. Noted that the paint formulation with HS40 (Comp. Ex 5β) showed a viscosity increase to over 2000 cP at room temperature in less than 2 weeks, and Comp. Ex. 5γ had a precipitate evident after one week.

### Example 6: Corrosion Resistance Testing of DTM Coatings

DTM coatings were tested for their corrosion resistance using a salt spray performance test. DTM coatings prepared according to Example 5 were applied to hot-dipped galvanized (HDG) steel and samples were allowed to fully dry before testing. The DTM coated HDG steel was then subjected to accelerated corrosion testing according to ASTM B117 testing conditions, which included exposure to salt spray for 1000 hours.

Accelerated corrosion testing according to ASTM B117 salt spray protocols was carried out to determine the efficacy of the colloidal silicas in DTM coatings applied to various substrates. The test coupons included HDG steel coated by drawdown of the paint with a #75 wire-wound rod to yield a coating with a dry film thickness (DFT) of 50 μm after 3 days of drying at ambient temperature. Test coupons were allowed to dry for at least 7 days and were scribed with a carbide tipped scribe pen in an X pattern. The edges of the coupons were taped, and the coupons were placed in salt spray for a total duration of 1000 hours.

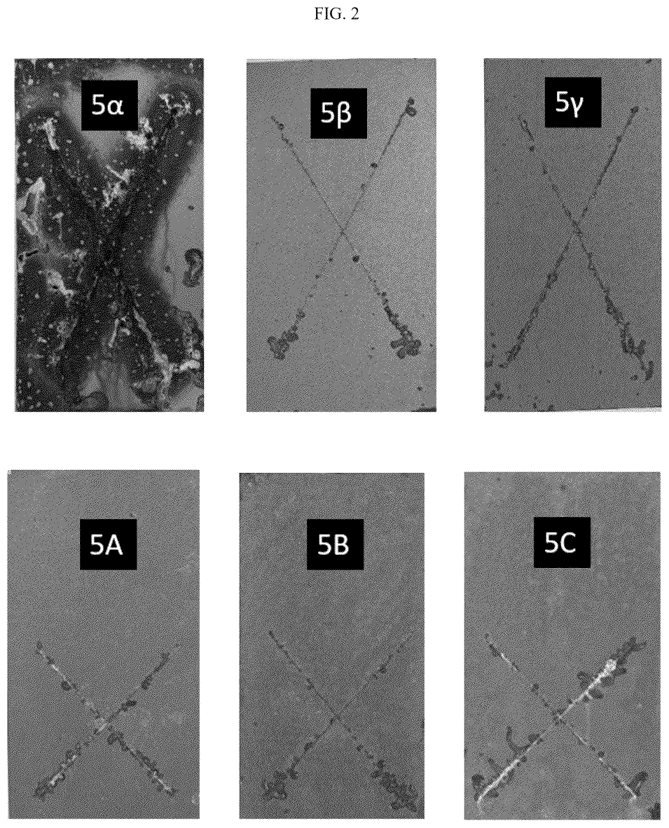

Following salt spray exposure, the coatings were rated on a scale of 0 to 5, with 0 being worst and 5 being best on adhesion loss at scribe and corrosion at scribe. More detail on the rating system is given in Table 14. Also following the salt spray exposure, the blistering was rated according to ASTM D714, which uses a set of reference photos which describe the frequency and size of blisters. Images of the results are provided in FIG. 2. Blistering Frequency: Few, Medium, Medium Dense, and Dense; Blistering Size: 8 (smallest), 6, 4, 2 (largest).

TABLE 14
Corrosion Evaluation Rating System:

| Rating | 5 | 4 | 3 | 2 | 1 | 0 |
|---|---|---|---|---|---|---|
| Adhesion loss at | No change | Average | Average | Average | Average | Average |
| scribe (not grading | from initial | delamination | delamination | delamination | delamination | delamination |
| scribe less than 10 | | width <1 mm | width <3 mm | width <6 mm | width <8 mm | width 8 mm |
| mm from the end) | | | | | | of more |
| | | | | | | from scribe |
| Corrosion at scribe | No change | Some gray and | Gray and white | Gray and white | Red and | Red |
| | from initial | white corrosion | corrosion on | corrosion 50% | gray/white | corrosion on. |
| | | on <10% of | 10%-50% of | to 100% of | corrosion on 50%- | 100% of |
| | | scribe | scribe | scribe | 100% of scribe | scribe |

Images of the results are provided in FIG. 2, and the adhesion loss at scribe, corrosion at scribe, blistering frequency, and blistering size are provided in Table 15 below.

TABLE 15
Salt Spray Corrosion Testing Ratings

| Corrosion | Comp. | Comp. | Comp. | | | |
|---|---|---|---|---|---|---|
| Test | Ex. 5α | Ex. 5β | Ex. 5γ | Ex. 5A | Ex. 5B | Ex. 5C |
| Adhesion loss | 0 | 4 | 3 | 2 | 3 | 3 |
| at scribe | | | | | | |
| Corrosion at | 0 | 3 | 4 | 2 | 3 | 2 |
| Scribe | | | | | | |
| Blistering | Dense | Few | Few | Medium | Medium | Medium |
| Frequency | | | | | | |
| (ASTM D714) | | | | | | |
| Blistering Size | 2 | 8 | 8 | 2 | 2 | 2 |
| (ASTM D714) | | | | | | |

The data in Table 15 and images of FIG. 2 indicate corrosion resistance for coatings made with functionalized colloidal silica of the present technology, evidencing the anticorrosion activity of coating compositions of the present technology.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified. Finally, it will be understood that disclosure of one of the foregoing terms also discloses embodiments using any of the other two terms or their equivalents.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed:

1.-46. (canceled)

47. A coating composition comprising
about 10 wt. % to about 90 wt. % water;
about 5 wt. % to about 80 wt. % of a binder; and
about 0.1 wt. % to about 20 wt. % of a colloidal silica functionalized with anionic molecules and/or a colloidal silica functionalized with neutral molecules.

48. The coating composition of claim 47, wherein the colloidal silica functionalized with anionic molecules comprises
silica particles comprising a surface, and
a structural unit according to Formula I, a structural unit according to Formula II,
a structural unit according to Formula III, a structural unit according to Formula IV, or a structural unit according to Formula V 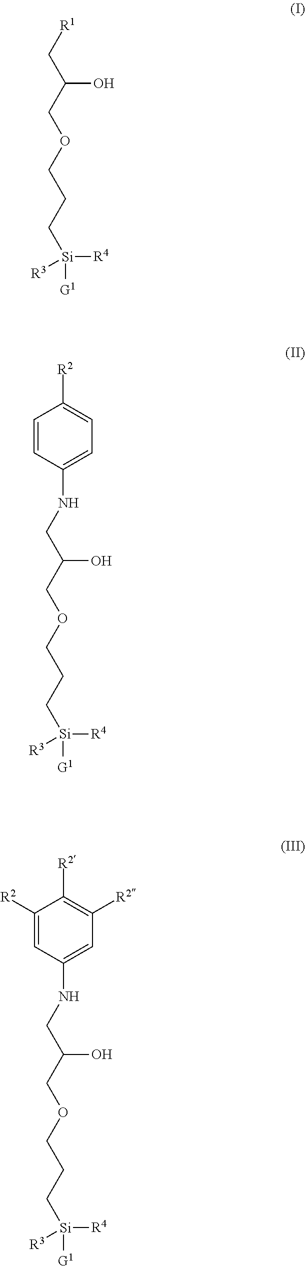 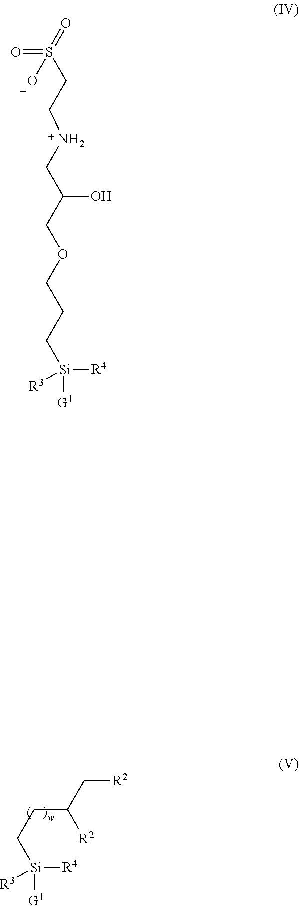
wherein
R¹ is —S—(CH₂)ₙR² where n is 1, 2, 3, 4, 5, or 6;
R² is independently at each occurrence —SO₃Y¹, —SO₃H, —SO₃—, —CO₂Y², —CO₂H, or —CO₂—;
R^{2′} and R^{2″} are each independently H, —SO₃Y¹, —SO₃H, —SO₃—, —CO₂Y², —CO₂H, or —CO₂—;
R³ is hydroxyl, alkoxy, aryloxy, or G²;
R⁴ is hydroxyl, alkoxy, aryloxy, or G³;
G¹, G², and G³ are each independently an oxygen atom of the surface of the silica particle, where G¹, G², and G³ are not the same oxygen atom;
w is 0, 1, 2, 3, 4, 5, or 6;
Y¹ is independently at each occurrence a cation; and
Y² is independently at each occurrence a cation.

49. The coating composition of claim 47, wherein the coating composition comprises about 2 wt. % to about 4 wt. % of the colloidal silica functionalized with anionic molecules.

50. The coating composition of claim 47, wherein the colloidal silica functionalized with anionic molecules comprises the structural unit according to Formula I and R¹ is —CH₂CH₂SO₃Y¹, —CH₂CH₂SO₃H, or —CH₂CH₂SO₃, Formula II and R² is —SO₃Y¹, —SO₃H, or —SO₃, or Formula V and R² is CO₂Y², —CO₂H, or —CO₂—.

51. The coating composition of claim 47, wherein the colloidal silica functionalized with neutral molecules comprises
silica particles comprising a surface, and
a structural unit according to Formula VI 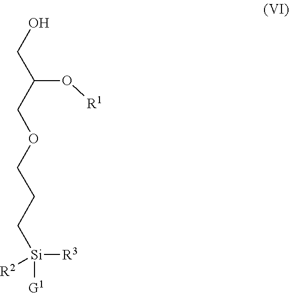
wherein
R¹ is
—CH₂(CHOH)ₓCH₂OH where x is 1, 2, 3, 4, 5, or 6, 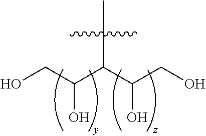
where y+z is 0, 1, 2, 3, 4, or 5, 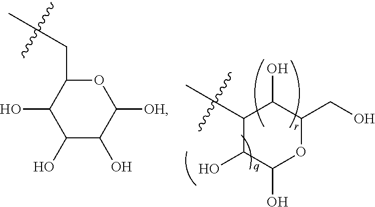
where q+r is 2; 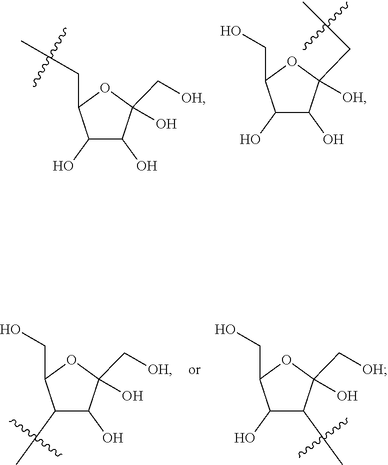 [SMILES: *CC1OC(O)(CO)C(O)C1O ; *CC1(O)OC(CO)C(O)C1O ; *C1C(CO)OC(O)(CO)C1O ; *C1C(O)C(CO)OC1(O)CO]
R² is hydroxyl, alkoxy, aryloxy, or G²;
R³ is hydroxyl, alkoxy, aryloxy, or G³; and
G¹, G², and G³ are each independently an oxygen atom of the surface of the silica particle, where G¹, G², and G³ are not the same oxygen atom.

52. The coating composition of claim 51, wherein the coating composition comprises about 4 wt. % to about 20 wt. % of the colloidal silica functionalized with neutral molecules.

53. The coating composition of claim 51, wherein colloidal silica functionalized with neutral molecules comprises the structural unit according to Formula VI and R¹ is

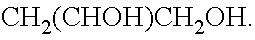

54. The coating composition of claim 51, wherein the coating composition further comprises (i) a binder, a coalescent, a nonionic surfactant, a rheology modifier, or a combination of any two or more thereof, (ii) a resin, a coalescent, a nonionic surfactant, and a rheology modifier, (iii) a pigment, a neutralizer, a matting agent, a biocide, a pigment dispersant, a defoamer, a wetting agent, a nonionic surfactant, a rheology modifier, or a combination of any two or more thereof, (iv) a pigment, a neutralizer, a biocide, a pigment dispersant, a defoamer, a wetting agent, a nonionic surfactant, and a rheology modifier, (v) a matting agent, or (vi) a coalescent.

55. The coating composition of claim 54, wherein the pigment comprises titanium dioxide, the neutralizer comprises 2-amino-2-methyl-1-propanol, the pigment dispersant comprises polyacrylic acid, the matting agent comprises sodium-potassium alumina silicate, the coalescent comprises 2,2,4-trimethyl-1,3-pentanediol monoisobutyrate, or the binder comprises an acrylic latex.

56. The coating composition of claim 47, wherein the coating composition when dried exhibits at least one of (i) an enhanced dirt pick-up resistance, (ii) a DPUR Rating of 2 or 3, (iii) enhanced corrosion resistance, (iv) an adhesion loss at scribe of 2, 3, 4, 5, or any range including and/or in-between any two of these values, or (v) a corrosion at scribe of 2, 3, 4, 5, or any range including and/or in-between any two of these values, and when liquid exhibits at least one of (vi) an enhanced ICI viscosity stability and/or enhanced KU viscosity stability, (vii) a change in ICI viscosity value of less than 25% on an absolute basis upon aging at 52° C. for 4 weeks, (viii) a change in KU viscosity value of less than 25% on an absolute basis upon aging at 52° C. for 4 weeks, (ix) an enhanced rheological stability, (x) a viscosity of less than 1,000 cP after aging at 50° C. for 4 weeks, or (xi) a change in viscosity of less than 100% on an absolute basis upon aging at 50° C. for 4 weeks.

57. A method of making a coating composition, the method comprising combining water, a binder, and a colloidal silica functionalized with anionic molecules and/or a colloidal silica functionalized with neutral molecules to generate a first mixture, where the first mixture comprises
about 1 wt. % to about 50 wt. % water;
about 5 wt. % to about 80 wt. % of the binder; and
about 0.1 wt. % to about 20 wt. % of the colloidal silica functionalized with anionic molecules and/or the colloidal silica functionalized with neutral molecules.

58. The method of claim 57, wherein the colloidal silica functionalized with anionic molecules comprises
silica particles comprising a surface, and
a structural unit according to Formula I, a structural unit according to Formula II,
a structural unit according to Formula III, a structural unit according to Formula IV, or a structural unit according to Formula V 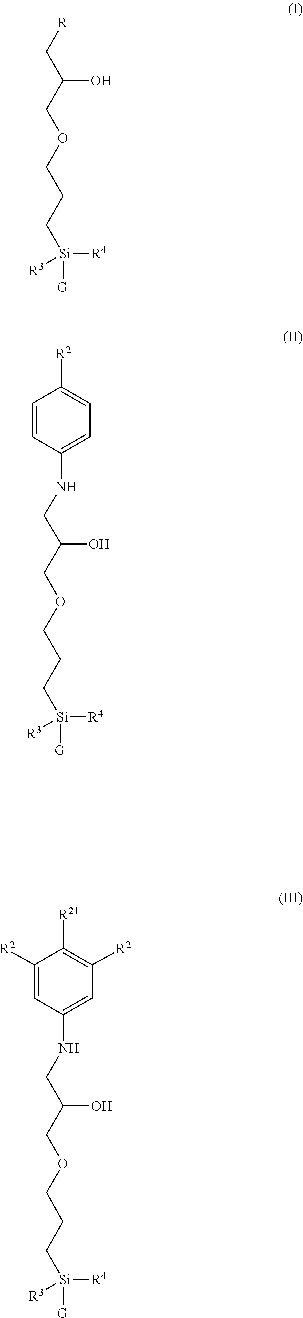 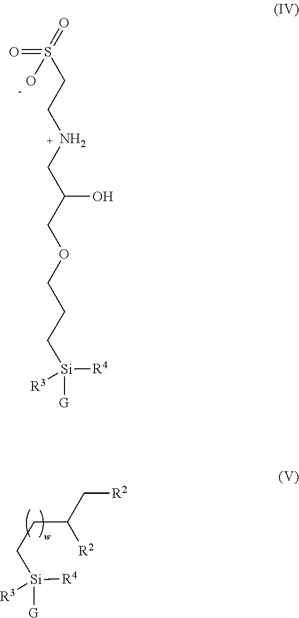
wherein
R¹ is —S—(CH₂)ₙR² where n is 1, 2, 3, 4, 5, or 6;
R² is independently at each occurrence —SO₃Y¹, —SO₃H, —SO₃—, —CO₂Y², —CO₂H, or —CO₂—;
R^{2′} and R^{2″} are each independently H, —SO₃Y¹, —SO₃H, —SO₃—, —CO₂Y², —CO₂H, or —CO₂—;
R³ is hydroxyl, alkoxy, aryloxy, or G²;
R⁴ is hydroxyl, alkoxy, aryloxy, or G³;
G¹, G², and G³ are each independently an oxygen atom of the surface of the silica particle, where G¹, G², and G³ are not the same oxygen atom;
w is 0, 1, 2, 3, 4, 5, or 6;
Y¹ is independently at each occurrence a cation; and
Y² is independently at each occurrence a cation.

59. The method of claim 57, wherein the first mixture comprises about 2 wt. % to about 4 wt. % of the colloidal silica functionalized with anionic molecules.

60. The method of claim 57, wherein the method comprises combining water, the binder, the colloidal silica functionalized with anionic molecules, and one or more of a neutralizer, a matting agent, a biocide, a pigment, a pigment dispersant, a defoamer, a wetting agent, or a nonionic surfactant, to provide the first mixture.

61. The method of claim 57, wherein the method further comprises mixing the first mixture with a coalescent, a rheology modifier, or a combination of any two or more thereof, to provide the coating composition.

62. The method of claim 57, wherein the colloidal silica functionalized with anionic molecules comprises the structural unit according to Formula I and R¹ is —CH₂CH₂SO₃Y¹, —CH₂CH₂SO₃H, or —CH₂CH₂SO₃—, Formula II and R² is —SO₃Y¹, —SO₃H, or —SO₃, or Formula V and R² is CO₂Y², —CO₂H, or —CO₂—.

63. The method of claim 57, wherein the binder comprises an acrylic latex.

64. The method of claim 57, wherein the colloidal silica functionalized with neutral molecules comprises
silica particles comprising a surface, and
a structural unit according to Formula VI 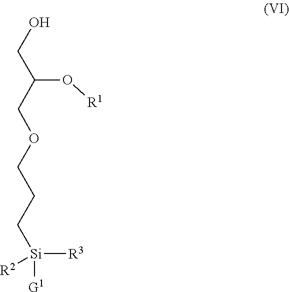
wherein
R¹ is
—CH₂(CHOH)ₓCH₂OH where x is 1, 2, 3, 4, 5, or 6, 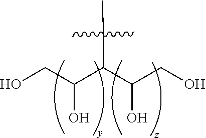
where y+z is 0, 1, 2, 3, 4, or 5, 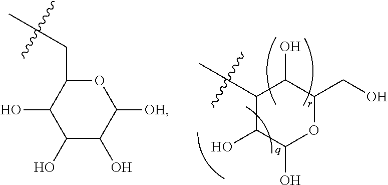
where q+r is 2; 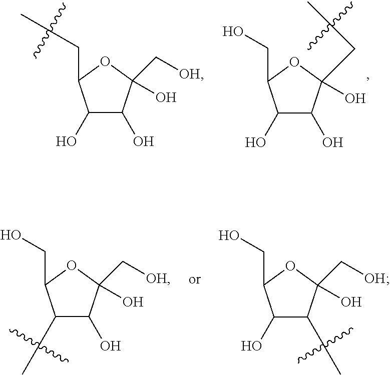 [SMILES: *CC1OC(O)(CO)C(O)C1O ; *CC1(O)OC(CO)C(O)C1O ; *C1C(CO)OC(O)(CO)C1O ; *C1C(O)C(CO)OC1(O)CO]
R² is hydroxyl, alkoxy, aryloxy, or G²
R³ is hydroxyl, alkoxy, aryloxy, or G³; and
G¹, G², and G³ are each independently an oxygen atom of the surface of the silica particle, where G¹, G², and G³ are not the same oxygen atom.

65. The method of claim 64, wherein the coating composition comprises about 4 wt. % to about 20 wt. % of the colloidal silica functionalized with neutral molecules.

66. The method of claim 64, wherein the coating composition further comprises (i) a coalescent, a surfactant, a rheology modifier, or a combination of any two or more thereof, or (ii) or a coalescent, a surfactant, and a rheology modifier.

67. The method of claim 64, wherein the colloidal silica functionalized with neutral molecules comprises the structural unit according to Formula VI and R¹ is CH₂(CHOH)CH₂OH. [chemical structure]
